(19) United States
(12) Patent Application Publication
(10) Pub. No.: US 2013/0255696 A1
(43) Pub. Date: Oct. 3, 2013

(54) Synergistic Posture System

(71) Applicant: Dawne Fraser, Head of St. Margaret's Bay (CA)

(72) Inventor: Dawne Fraser, Head of St. Margaret's Bay (CA)

(21) Appl. No.: 13/675,469

(22) Filed: Nov. 13, 2012

Related U.S. Application Data
(60) Provisional application No. 61/558,560, filed on Nov. 11, 2011.

(51) Int. Cl. A61H 1/02

(52) U.S. Cl. CPC A61H 1/0229
USPC 128/845

(57) ABSTRACT

The present application pertains to dynamic systems for improving posture in humans through the use of chairs, wheelchairs, walkers, standing devices, wearing devices, sports equipment or other seating or mobility devices that are designed to provide one or more contact points or postural points on the body, which stimulate proper posture and awareness of posture, while allowing movement, without the requirement for physical restraints.

### CROSS-REFERENCE

The present application claims priority to U.S. Provisional Patent Application No. 61/558,560, filed on Nov. 11, 2011, the entirety of which is incorporated herein by reference.

### FIELD OF THE INVENTION

The present application pertains to a dynamic system for improving posture in humans through the use of contact surfaces corresponding to one or more contact points or postural points on the body. More specifically, the present application relates to a postural system comprising contact surfaces positioned to apply pressure to one or more contact points or postural points on the body, which stimulate proper posture and awareness of posture without the requirement for physical restraints.

### BACKGROUND

The discovery of the significance of stimulating a human being's natural posture with the invention was first noticed with the dramatic beneficial results in schoolchildren. The extensive range of improved abilities directly observed in grades 4, 5, and 6 were increased learning, sustained attention, fine motor skills: reading, writing, speaking, scissor cutting, visual tracking, etc. Gross motor skills: stamina, walking, running. Additional benefits observed were more energy for socialization and play, participation in conversations while seated and eating lunch, all with much calmer, more appropriate behaviour etc.

Human beings may have a broad range of postural requirements for seating, walking and supine positions, depending on various physical, psychological or neurological conditions. Postural problems can occur in disabled persons with physical, neurological or other conditions.

Postural problems exist not only in persons with various conditions, but can extend to the general population. For example, school-age children may have poor posture which has contributed to learning and/or behavioural problems as well as chronic posture-related physical problems. The elderly may suffer from postural problems caused by physical deterioration of the spine or musculature. Infants and toddlers may have poor posture, low muscle tone, or other abnormalities affecting natural posture.

Current seating and mobility devices for posture only address physical support through various means of external physical restraint, and do not invoke, stimulate or provide the means for a person to attain a proper posture through their own natural spontaneous ability and inherent awareness to maintain such a proper posture. These existing systems primarily are focussed on the special needs population and consist of various means of bracing and strapping, use of posture support harnesses or restraints of various kinds, all of which force the body into a proper position. Bracing, strapping or restraint stimulates a natural reflex of resistance at the point of contact from the surrounding muscles against the resistance point of the brace, strap or restraint. This resistance inhibits the ability of the person to attain a natural posture without support, and to be able to relax in this posture. With many of these systems, such as ergonomic seating for offices for able-bodied persons mainly address a 90° angle for limbs and joints positioning and more subtle bracing of elbow rests and contour seat/back cushioning, encourage persons to become dependent on the brace, strap or restraint. This, in turn, can result in the person losing the ability to maintain a spontaneous proper posture, which can generate many health and functional ability deficits.

Such means of restraint can be as simple as that disclosed in U.S. Pat. No. 3,635,526, whereby a physical restraint bar is used across a person's lap while seated.

In another example, U.S. Pat. No. 4,617,919 discloses a wheelchair with posture supports, in which a wheelchair has a plurality of posture supports for adjustably supporting the neck, thoracic cavity and thighs. Each of the supports is independently and three dimensionally adjustable so as to restrain a wheelchair bound individual. The various supports are adjustable via a plurality of rods and set screw bound cylindrical couplers

Other examples are the sit-on walkers used for people with cerebral palsy, such as the Mulholland Gait Master walkers (www.mulhollandinc.com/GaitMaster.asp). These systems use bracing as the main means by which a physical posture is improved while leaving the legs free to stimulate ambulation, the brace point of contact actually inhibits forward momentum even for an able-bodied person when demonstrating the device, sometimes causing extensive forward pelvic thrust to initiate movement off the supporting object.

In another example, a device called Spine Worx Posture Align Device (www.spineworx.com) is a back support system that utilizes a person's body weight to apply controlled pressure to the bones of the back. The device consists of two injection-molded contoured padded rails to fit the shape of the mid- and lower back.

These systems do not provide a means of spontaneous and self-achieved relaxed posture to occur.

Previous postural systems are deficient because they force compliance to a specific posture with constraint or restraint, and do not stimulate proper posture through the body's natural tendency to maintain an aligned position. The prior systems often over stimulate the areas of constraint or restraint.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present application describes a synergistic postural system that stimulates and triggers a spontaneous correct and natural posture by providing contact with one or more of a plurality of contact points on the body. The inventor has identified contact points from observation of individuals' postural responses to light, non-constrained contact to various points on the body.

The present application describes a postural system that assists proper posture through gentle sensory stimulation at key contact points on the body, which naturally triggers and/or restores balanced stability of the body's upright sitting/standing/walking posture. A synergistic effect is produced by stimulating more than one of the plurality of contact points to trigger the body's own natural mechanism of upright dynamic stability and maintenance of proper posture. Once the synergistic effect is stimulated and movement is unimpeded the natural posture continuously is spontaneously activated. This effect gently trains the body to sustain a more natural posture.

The present postural system is useful in assisting individuals of various fitness levels and conditions, including but not limited to, individuals with high/low muscle tone, partial paralysis, frequent spasms, seizures, sensory challenges or attention problems. The contact points act as rest points for the body, and stimulation of the rest points activate the body to an upright posture, which can benefit the body, for example, by enabling increased fine motor coordination, sustained alertness, relaxation response, increased learning capacity, improved vision and speech, increased sensory motor integration, etc.

The presently described system can provide a significant improvement over existing postural systems by stimulating the body to attain more naturally aligned proper posture spontaneously and continuously, without use of forceful restraints or constraints.

The present system is based on the inventor's identification and characterization of key contact points of the human body, which when contacted with a light touch, or pressure, such as from a postural system, will stimulate a more correct posture in the body. The postural system naturally allows for stability of the core trunk of the body which then allows for physical relaxation and the ability to place greater attention on gross and fine motor skills. Because of the dynamic postural stimulation, fine motor coordination is enhanced and evident within minutes. The present postural system can be of significant benefit to people with postural dysfunction, and people without any dysfunction will also benefit, and to a greater degree. To that degree, the invention can be effectively used, for example, by school children to improve their ability to learn and office staff to maintain work efficiency.

### BRIEF DESCRIPTION OF THE FIGURES

FIG. 1 illustrates a human body. FIG. 1A depicts the location of contact points on the human body (front view).

FIG. 1B depicts the location of additional contact points on the human body (back view).

FIG. 2A depicts a partially exploded (and enlarged) side view of a synergistic Postural System Application for Seating, according to one embodiment of the present application, that can be incorporated in, for example, a chair, rocking chair, wheelchair, stool, bench or seat which incorporates a plurality of contact surfaces in a synergistic manner; this design can be modified for the specific requirements of the application or the needs of the user.

FIG. 2B shows specific seating measurements, seat angles and adjustability range for size medium-small chair and a size large-medium chair according to a specific example of the embodiment shown in FIG. 2A.

FIG. 2C depicts an example of the embodiment of FIG. 2A, as a modular design, which can include the Cross Sternum Support and other accessories.

FIG. 2D shows details of a Cross Sternum Contact strap, for use in the Postural System shown in FIG. 2A, which includes an adjustable contact foam sternum ball on an adjustable strap that can also be fit to, for example, seating (e.g., chairs, rockers, stool, such as low stools with high backs), walkers, standing devices, vests, stools, vehicle seats, wheelchairs, seatbelts, etc.

FIG. 3A depicts a Low Stool Support according to one embodiment of the present application, which includes at least some elements of the system shown in FIG. 2B, but is adapted for use as a portable low stool or chair device.

FIG. 3B depicts a Low Stool Base, according to one embodiment of the present application, with Back and Cross Sternum Support, or headrest, which includes at least some the elements of the system depicted in FIG. 2C, and which can be integrated in seating for sailing, sit skiing, motor cycles backseat, showers, bicycles, tricycles, rockers, go-carts, etc.

FIG. 3C depicts a Mobile Low Stool with Mid-back Support according to one embodiment of the present application, which can be used with casters for low desk work, filing, etc.

FIG. 4A depicts a Crawler, according to one embodiment of the present application, which promotes natural crawling for toddlers and children, with correct head-position, for hands-free for exploration and eye tracking, thereby enabling natural mobility sensory feedback at sternum and hips.

FIG. 4B depicts a Low Bench Crawler, according to one embodiment of the present application, which promotes natural crawling, for teens, youth and adults, thereby enabling mobility and contact point support for hands-free work.

FIG. 5A depicts an Ambulation Hip Joint/Pelvic Strap, according to one embodiment of the present application, which can be used in combination with the devices shown in FIGS. 5B, 6A, 7C, (and other devices this contact point is built in).

FIG. 5B depicts a Standing Walker, according to one embodiment of the present application, which allows natural posture and natural gait movement. Contact surfaces for providing constant intermittent pressure to contact points #17 and #19 can be incorporated in the Standing Walker to initiate and stimulate natural gait patterns. Also depicted are full back, head and sternum accessories that are optionally incorporated in or used with the Standing Walker.

FIG. 6A depicts a Service Animal/Pulley System Device, according to one embodiment of the present application, adapted for use with service dogs, or other means of assistance to generate, increase, or maintain walking, jogging, or running mobility in a user (which is a ‘sequence of energy activation’, that takes approximately one to 3 seconds per cycle).

FIG. 6B depicts a Postural Vest, according to one embodiment of the present application, which can be customized to incorporate a plurality of contact surfaces positioned and sized to provide constant intermittent pressure to contact points on users of various sizes, from infants to adults.

FIG. 6C depicts a Team Walking Harness, according to one embodiment of the present application, which is an Adjustable Adult-to-child walking Harness for safety and training designed to assist natural posture/balance and mobility with the reinforcing contact at the hips and pelvic points, for walking, climbing, standing and stairs, while allowing hands-free exploration.

FIG. 6D depicts a Toddler Walking Harness, according to one embodiment of the present application, which is a child's hands-free beginner Walker harness that allows natural balance/posture for exploration. In use, the parents grasp the handle to maintain safety and direct contact with the child's pelvic/hip contact point#18, #5. Additional back webbing stimulates contact point#1, #6 and front cross-sternum webbing stimulates point#7 encouraging upright self-correction. The design can provide comfortable, natural walking for the child and natural ease of use for the parent.

FIG. 6E depicts a Toddler Walker, according to one embodiment of the present application, which is a child's hands-free beginner Walker that stimulates natural balance/posture for exploration, enables the parent(s) to maintain safety and contact with the child's pelvic/hip points, rather than guiding them by grasping their hand/arm above their heads.

FIGS. 7A & 7B depicts a Standing Device, according to one embodiment of the present application, which has a typical design for a standing device or parapodium device, Front 7A and Back 7B, and incorporates all contact surfaces as required.

FIG. 7C depicts a Crutch Device, according to one embodiment of the present application as adapted for use with crutches or other means of assistance to generate Synergistic Posture Balance, to first effortlessly activate and stabilize natural posture and to increase, or maintain mobility.

FIG. 7D depicts a Sitting Harness, according to one embodiment of the present application, which can be worn independently by a user for sitting in, e.g., chairs, horse saddles, kayaks, canoes, cars, bicycles, tricycles, cars, tractors, school chairs, or other applications such as trees.

FIG. 8 depicts a Modular Arm Mobility Device, according to one embodiment of the present application, which includes a lightweight shoulder harness that aids in providing head uprightness, arm-control and hand-eye coordination and grasping in a user.

FIG. 9A, 9B depict a modular Clavicle/Shoulder Harness, (FIG. 9A) according to one embodiment of the present application, which holds the shoulders and clavicles in the correct postural plane using contact surfaces for contact points #7, 12, 6, 16, while allowing complete arm mobility. See also be FIG. 9B directly attached to additional contact surfaces for contact points #5, 18 increasing body mobility for daily activity or sports.

FIGS. 10-30 depict the precise uprighting effects on posture for each specific positions of the twenty-one contact points on the human body.

### DETAILED DESCRIPTION OF THE INVENTION

Unless defined otherwise, all technical and scientific terms used herein have the same meaning as commonly understood by one of ordinary skill in the art to which this invention belongs.

Unless the context clearly indicates otherwise, as used herein plural forms of the terms herein are to be construed as including the singular form and vice versa.

The terms “comprises” and “comprising,” as used herein will be understood to mean that the list following is non-exhaustive and may or may not include any other additional suitable items, for example one or more further feature(s), component(s) and/or ingredient(s) as appropriate.

As used herein, the term “contact point”, or “CP”, or postural point, is used to refer to a particular position or location on the human body that is sensitive to the application of external pressure to stimulate the body to produce a postural response, e.g., a more upright posture.

As used herein, the term “contact surfaces” is used to refer to a surface on a support or mobility assistive device or apparatus, positioned to provide a constant pressure to a contact point on the body of the user.

A used herein, the term “postural system” is used to refer to a device or apparatus, or support or mobility assistive device or apparatus comprising a plurality of contact surfaces. The contact surfaces in the postural system can function synergistically to dynamically stimulate an upright posture in the body of the user.

The present application describes a dynamic postural system that assists proper posture through gentle sensory stimulation at key contact points on the body, via a plurality of contact surfaces, which naturally triggers and/or restores balanced stability of the body's upright sitting/standing/walking posture. A synergistic effect is produced by stimulating more than one of the plurality of contact points to trigger the body's own natural mechanism of upright dynamic stability and maintenance of proper posture. Once the synergistic effect is stimulated and induced the natural posture is continuously and spontaneously activated. This effect gently trains the body to sustain a more natural posture.

The term “synergistic effect,” as used herein in reference to an effect of using the present postural system, refers to an effect that is created as each contact point stimulates an area of the body, which overlaps and enhances stimulation of other areas of the body by other contact points. This overlapping enhancement effect is best described as ‘synergistic’, since the total effect is more than the additive effect of stimulation of single contact points individually. For this reason, it is important to utilize a plurality of contact points simultaneously for the present system to be effective.

The term “dynamic,” is used herein in referring to the present postural system to indicate that the system is an interactive system that stimulates an active ‘energetic effect’ throughout the body of the user to produce a synergistic postural response, which appears naturally inherent within the body. Such an energetic effect, or energy flow, is an observable, effortless, spontaneously occurring postural change in the corresponding areas of the body when a contact point is stimulated. By contrast, systems that use bracing (such as, restraints or straps) force changes in a user's posture that are not effortless or spontaneous.

The present system is based on the inventor's identification and characterization of key contact points on the human body, which, when contacted with a light touch or pressure, such as from a postural system, will stimulate a more correct posture in the body. The postural system naturally stabilizes the core trunk of the body which then allows for physical relaxation and the ability to place greater attention on gross and fine motor skills. Because of the dynamic postural stimulation, fine motor coordination is enhanced and evident within minutes. The present system can provide a significant benefit to people with postural dysfunction, and people without any dysfunction can also benefit, and to a greater degree. The present system can also be used effectively, for example, by school children to improve their ability to learn and office staff to maintain work efficiency, through improving posture and/or providing natural stabilization of the core of the user's body.

The present inventor has now identified that application of a gentle, light pressure on a contact point will stimulate a corresponding energetic effect. The light pressure is maintained at least until the desired energetic effect is observed. Only light pressure is required to produce an energetic effect—i.e., light contact with, or sense of touch to the body, at a contact point can be sufficient.

The application of a gentle, light pressure to one or more contact points of a user, allows the user a wide range of body movement for the area in contact, yet re-stimulates the dynamic effect when the body rests. A brief touch can have the same effect to stimulate the corresponding area of the body's posture. However, providing continuous intermittent contact has more benefits than sustained contact. Allowing the natural movement of the body and continuous re-contacting or intermittent contact (on and off for seconds at a time) dynamically produces the desired synergistic effect of more natural posture in the user. As such, the postural system described herein, does not include restraints or other means for maintaining the user in sustained contact with the contact surfaces.

Over a multi-year (approximately 18 years) period, the inventor of the present invention experimented with various means to improve on existing postural systems in order to achieve a more balanced, relaxed posture with the resulting improvements in mobility, bodily function, increased dexterity, vision and speech and physiological balance.

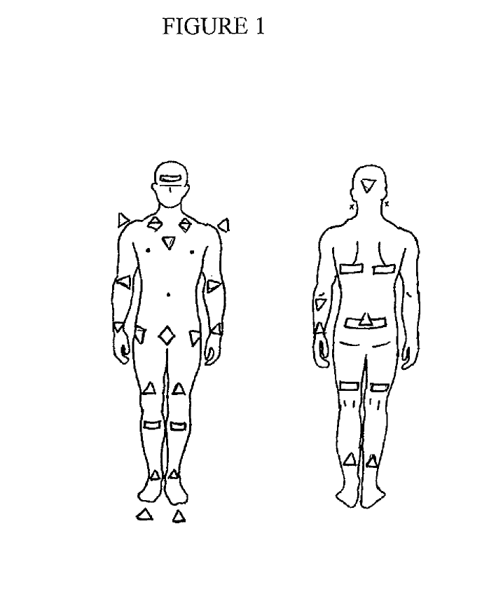

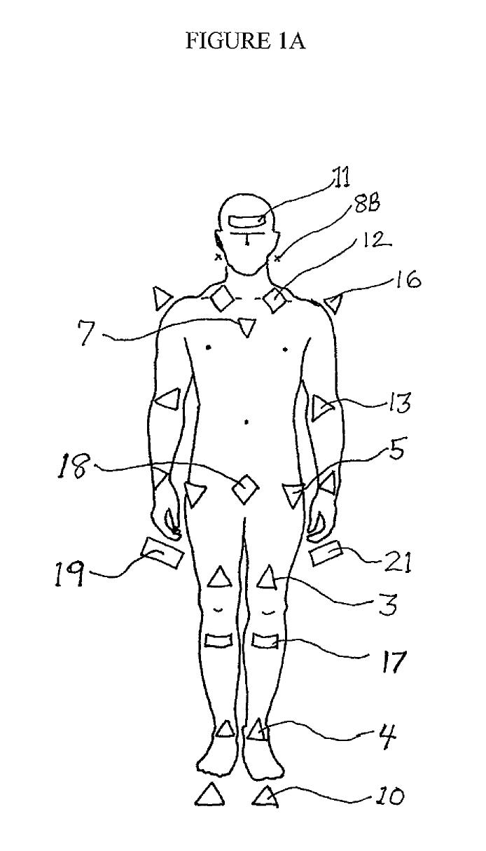

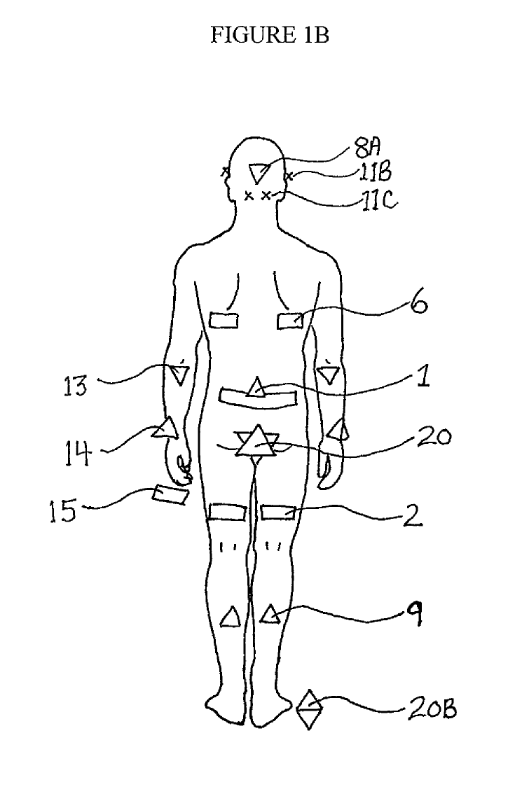

The following describes contact points that have now been identified and characterized. The approximate location of each of these contact points is depicted in FIG. 1A (front view) and FIG. 1B (back view). FIG. 1A; Contact Point #3 Knee Angle/Back Angle is created by the proper angle of the bent knee while in a seated position, between 60 to 85 degrees, more preferred between 70 to 76 degrees with the most preferred angle at 73 degrees. Contact Point #4 Heel Angle is created by the proper angle of the ankle, such that the angle is bent more than 90 degrees, with the best angle at 75-80 degrees. Contact Point #5: Hip Joint is created by light contact to the sides of the hips, at the trochanters hip joint region. Contact Point #7 Sternum is located at the center of the sternum in the front of the chest. Contact Point #8B Mastoid Bone is the mastoid bones located at the back and sides of the head. Contact Point #10 Ankle Flexion is created by dorsal flexion (minimum of 3 degrees and bending of the ankles through medial rotation. Contact Point #11 Forehead is located approximately one inch above the eyebrows directly in the center of the forehead extending parallel above eyes. Contact Point #12 Collarbones are located on one or both of the collarbones. Contact Point #16 Shoulder is located at the outside center of the shoulder, about one inch just below the top of the rotator cuff. Contact Point #17 Below Knee is located 2-3″ below the patella of the knee on the center of the leg. Contact Point #18 Pelvic Bone is located just above the pubic bone, with a slight contact of the pubic bone. Contact Point #19 Standing fingers, Synergistic Posture Balance, are located on the palm of the 4 fingers at the intermediate phalanges when slightly flexed, (to maintain contact with a handle device). Contact Point #21 Walking Fingers, Synergistic Dynamic Balance, are located on the palm of the 4 fingers at the intermediate phalanges when slightly flexed to maintain contact with a handle in momentum, while the ipsilateral arm has relaxed extension. FIG. 1B (back view): Contact Point #1 Low Back is located in the center of the back, immediately below the lumbar region of the spine. The contact point is located precisely at the L3 vertebrate. Contact Point #2 Under Thigh is located on the underside of the leg, approximately two-thirds of way down from the hip and to the knee. Contact Point #6 Mid Back are paired contact points located at approximately 3″ to either side of the spine in the mid-back under the shoulder blades (scapula) and rib cage, at the T4, T5 or T6 vertebrate. Contact Point #8A Back of Head is located at the occipital bone or prominent bone, above the mastoid bones at the back and center of the head. Contact Point #9 Crossleg is created by crossing the legs at the shin (when sitting, lying, or standing) and constitutes the point of contact between the front of one shin and back of the other. Contact Point #11B Zygomatic Arch is located at the zygomatic process on both sides of the face. Contact Point #11C Superior Nuchal is located on base of skull on the superior nuchal external occipital line. Contact Point #13 Elbows are located about 1-2 inches under each elbow on the ulna. Contact Point #14 Wrist is located one inch medially of the prominent bone of the wrist, and the underside of an inverted palm. Contact Point #15 Small Finger is located on the inside of small finger, at approximately between second digit. Contact Point #20 Tail Bone is located at the base of and including the tailbone and internal pelvic area. Contact Point #20B Plantar Metatarsus is located on the plantar surface, just behind the balls of each foot.

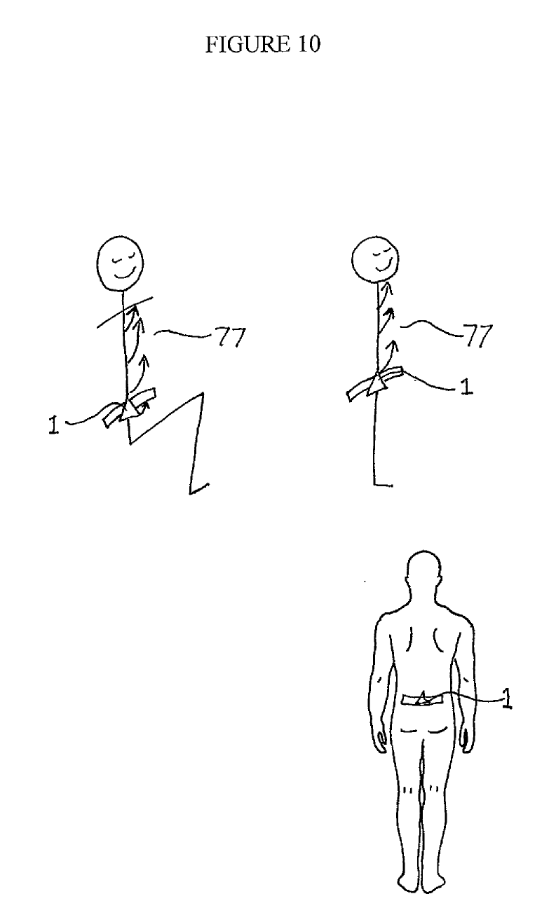

Contact Point 1: Low Back, FIG. 10.

This contact point is located in the center of the back, immediately below the lumbar region of the spine. The contact point is located precisely at the L3 vertebrate. Gentle pressure on this point provides a stimulus for the proper alignment of the spine and correct head position. Contact Point 1 generates: elevation postural energy flow up the ventral spine, by up arrows 77 increasing elevation of natural upright head position.

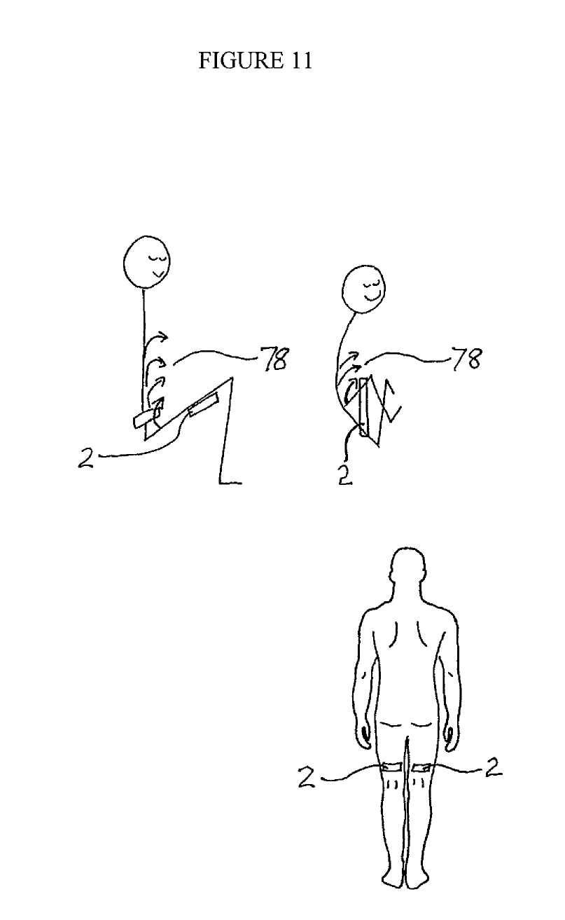

Contact Point 2: Under Thigh, FIG. 11.

This contact point is located on the underside of the leg, approximately two-thirds of way down from the hip and to the knee. This contact point provides a stimulus to increase muscle tone for sitting and crossed legged sitting, or while walking through the use of walking straps. Contact at this point also stimulates proper upright alignment of the spine and awareness of the sternum. Contact Point 2 generates: elevation postural energy flow up from sacrum ventrally up spine to tip of sternum, by arrows 78.

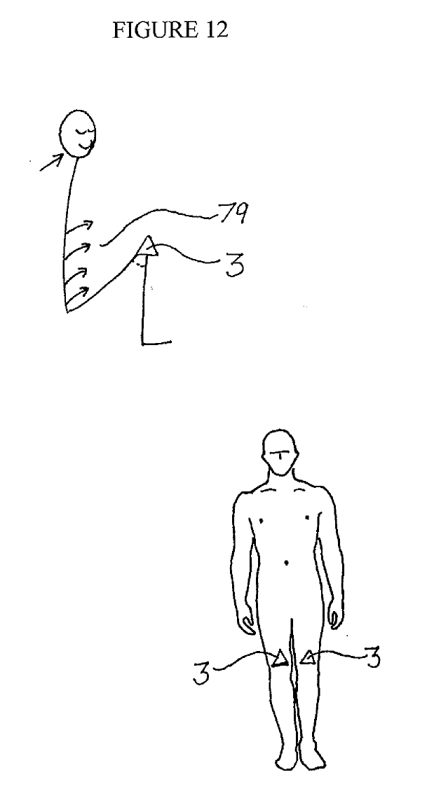

Contact Point 3: Knee Angle/Back Angle, FIG. 12.

This contact point is created by the proper angle of the bent knee while in a seated position, between 60 to 85 degrees, more preferred between 70 to 76 degrees with the most preferred angle at 73 degrees. This contact point tends to relax the jaw, and the neck resumes a more natural posture. Contact Point 3 generates postural energy flow: from the coccyx elevating distinctly forward up spine to tip of sternum, by arrows 79.

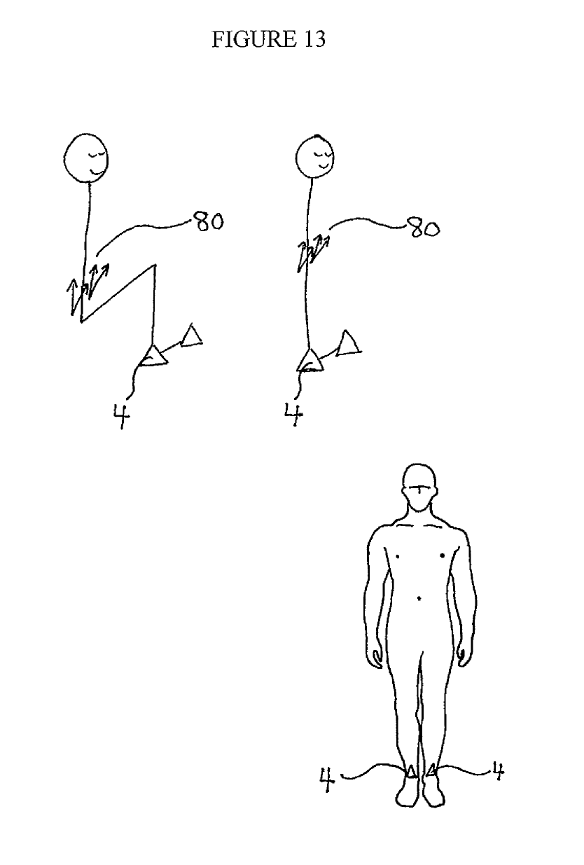

Contact Point 4: Heel Angle, FIG. 13.

This contact point is created by the proper angle of the ankle, such that the angle is bent more than 90 degrees, with the best angle at 75-80 degrees. The use of this contact point provides greater stability, and creates additional awareness of the lower back and sternum areas. This occurs when seated or walking, by arrows 80. Contact Point 4, which functions when feet are crossed in a seated position, generates a pronounced elevating postural energy flow at hips and stimulating the sternum area, by arrows 80.

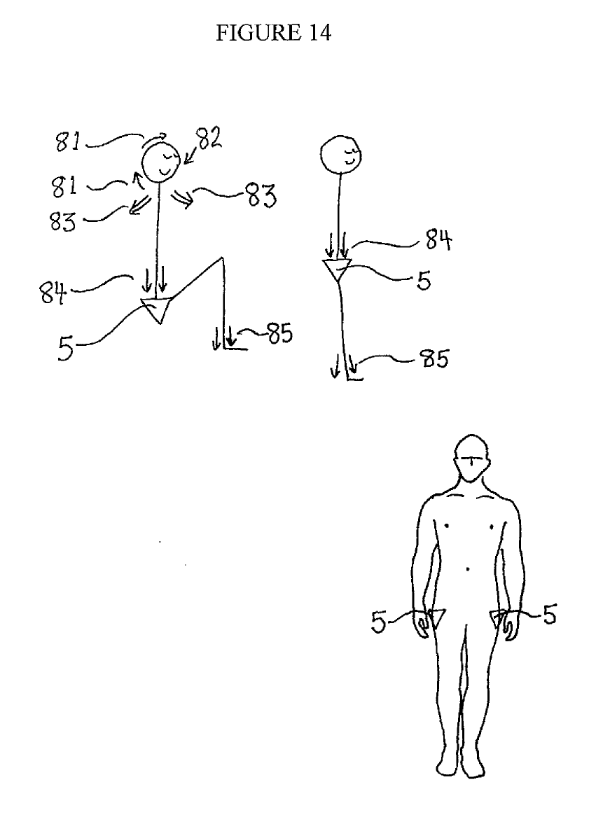

Contact Point 5: Hip Joint, FIG. 14.

The contact point is created by light contact to the sides of the hips, at the hip joint region. The point creates greater postural stability, and stimulates elevation of back of head 81, so chin alignment is depressed (lowered) to a tensionless position 82, and a relaxation (lowering) 83 of the shoulder blades. The contact point increases the freedom of movement (rotation, flexion, extension) of the neck and head, while stimulating elongation of the spine 84, and sensory awareness of the feet 85 naturally-counter-to-gravity. This contact point can be stimulated in both the seated, lying and walking position. Contact Point 5 generates postural energy flow to elevate the upper body of shoulders neck and head, while simultaneously generating natural counter to gravity at ‘sitting bones’ and heels:

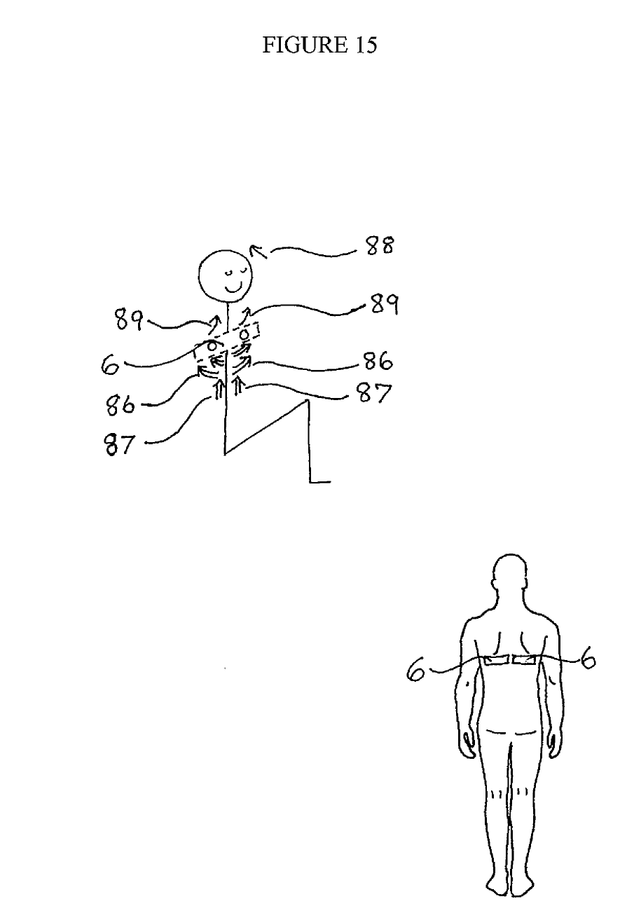

Contact Point 6: Mid Back, FIG. 15.

These paired contact points are located at approximately 3″ to either side of the spine in the mid-back under the shoulder blades (scapula) and rib cage, at the T4, T5 or T6 vertebrate. Only a light pressure is applied to these points, and not across the whole back. This point stimulates the rib cage to expand 86 and diaphragm to relax 87. It also directly assists upright head orientation 88 and reinforces stimulation of natural energy flow at hip joints and sternum contact points 89. Contact Point 6 generates postural energy flow which repeatedly stimulates a relaxing inhalation 86, 87, 89, and head upright orientation 88.

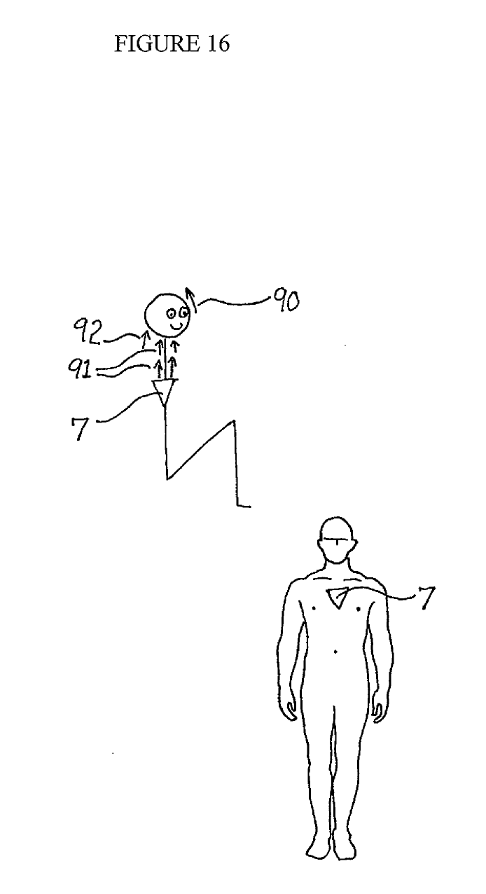

Contact Point 7: Sternum, FIG. 16.

This contact point is located at the center of the sternum in the front of the chest. The point can be utilized in either a seated, lying or standing position, including chairs, car seat belts, wheelchairs, etc., but any mechanical contacting device should ideally not touch any musculature. Only a light pressure is required to assist awareness of the body point. This point stimulates clearer vision and tracking of the eyes, easier chewing and swallowing, easier head rotation, talking and breathing, and maintains internal awareness of the head position 90, with more ease. Contact Point 7 repeatedly generates postural elevating energy flow up from sternum point 91, to provide stabilizing head 92 support and more energy for more clarity, alertness and fine motor functions.

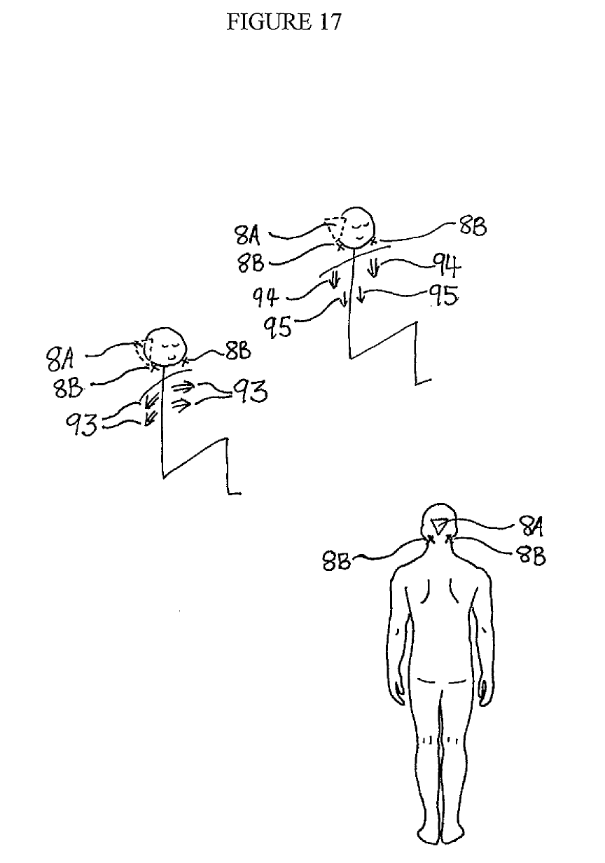

Contact Point 8A: Back of Head, FIG. 17.

The contact point is located at the occipital bone or prominent bone, above the mastoid bones at the back and center of the head. Only the center of the head should be contacted, and only a very light pressure is required to maintain awareness of that point. This point stimulates increased relaxation of neck/head/shoulders muscle tension, spasms or motor stress and cultivates subsequent recovery. It trains the head for the proper alignment and relaxation of the head and shoulders, and creates deeper breathing by expansion of the rib cage. Contact Point 8A generates postural energy flow to expand rib cage 93 and depress shoulders 94 to a natural resting position and release tension in the diaphragm 95.

Contact Point 8B: Mastoid Bone.

Closely related to contact point 8A is the mastoid bones located at the back and sides of the head. Very light contact at Contact Point 8B enhances CP#8A energy postural effects 93, 94, 95.

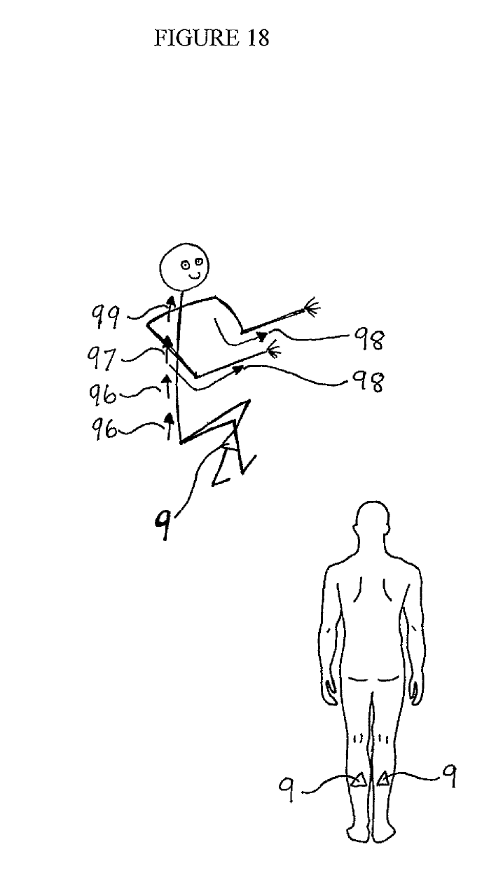

Contact Point 9: Crossleg, FIG. 18.

This contact point is created by crossing the legs at the shin (when sitting, lying, or standing) and constitutes the point of contact between the front of one shin and back of the other (preferred shin or dominant leg may increase flow of postural energy). This point stimulates more independent hand movement and freedom of upper body movement by stabilizing the lower body. Contact Point 9 generates postural energy flow straight up the spine 96, to stabilize the trunk and release shoulders 97 for freer movement, thus enhancing hand 98 dexterity. The head receives increased energy flow to stimulate more mobile head 99 control.

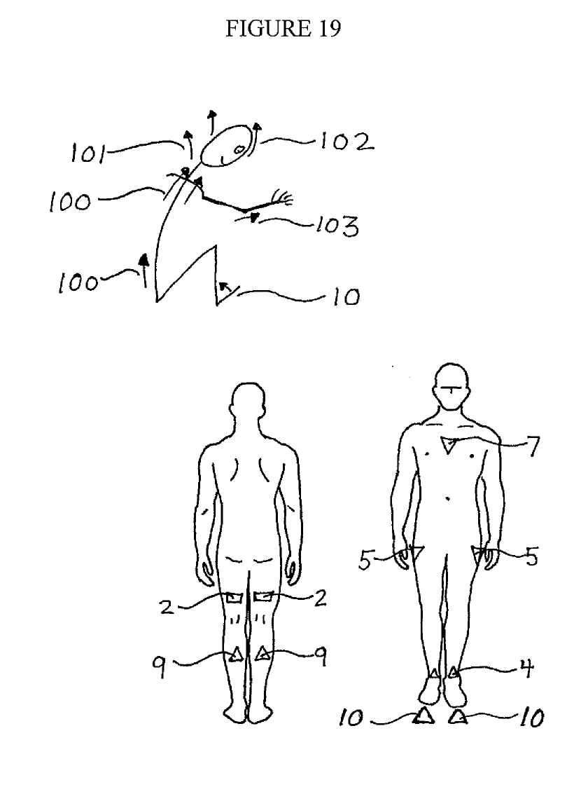

Contact Point 10: Ankle Flexion, FIG. 19.

This contact point is created by dorsal flexion (minimum of 3 degrees and bending of the ankles through medial rotation, usually as part of contact point #9. The point stimulates head control and posture, as well as hand-eye coordination and synergistically works with points #9, 5, 4, 7 and 2 to increase postural stability. Contact Point 10 generates postural energy flow from the tailbone 100 which extends the neck 101, elevating the head 102, allowing increased energy flow for dexterity 103, head control and hand-eye coordination.

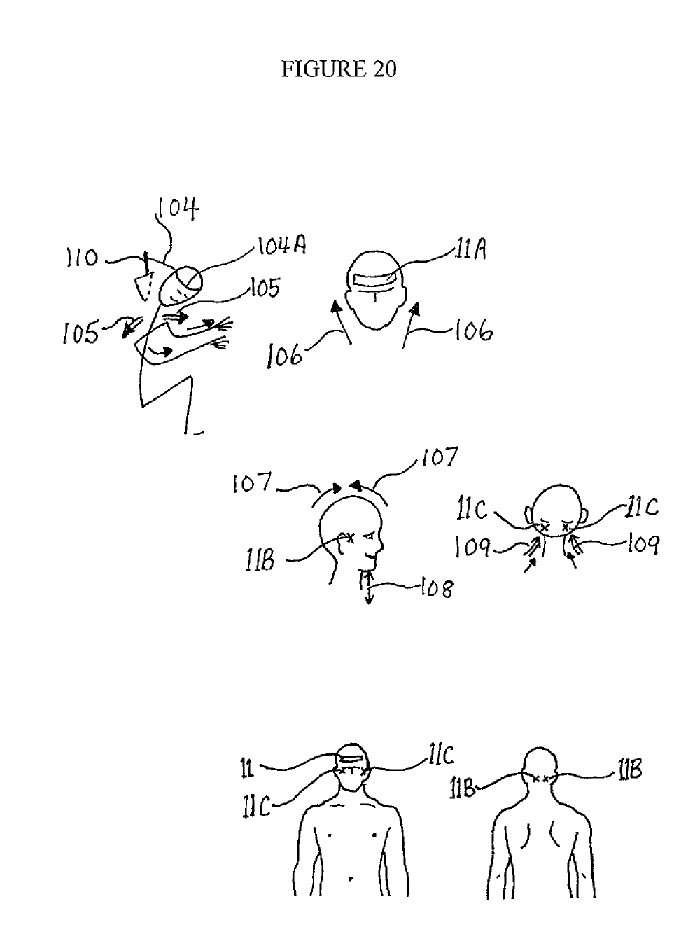

Contact Point 11: Forehead, FIG. 20.

This contact point, #11A is located approximately one inch above the eyebrows directly in the center of the forehead extending parallel above eyes. Contact with this point should be made through the use of a narrow (½″ to ¾″) headstrap 104A, which makes contact on the surface of this contact point #11A. The use of this forehead contact point allows the neck to relax, head to recover an upright natural position 106, and eyes to focus and track. The correct use of contact point #11A with persons having limited head control is useful to prevent over extension of neck and shoulder muscles. The use of a rear post 110, to a postural headrest device may be required which is 1″ to 3″ above the head depending on the height of the user and the dimensions of the postural system. A supporting tether 104, from the post to the headband 104A, at the occipital point, must allow range of motion preventing the muscles from experiencing full extension/flexion, enabling the head to respond to the postural energy flow 105, without recruiting any extraneous muscles. Over extension or flexion of the neck inhibits the body's natural spontaneous postural energy flow to circulate and inhibits the above listed benefits. The neck position and neck muscles must rest within the body's natural posture range so spontaneous synergistic upright natural posture occurs effortlessly. The synergistic effect of contact point #11A with contact point#7 stimulates effortless head lift 106, increasing in degree, as stamina is developed for more severely limited individuals. Individuals within normal postural range receiving stimulation pressure at Contact Point 11A experience equally significant effortless upright head posture 106, which is useful for driving, computer usage, etc. Contact Point 11B, stimulation of zygomatic arch, on both sides of the face, generates head elevation 107, with slight chin tuck 108, stability. Contact Point 11C, Superior Nuchal is located on base of skull on the superior nuchal external occipital line, stimulation of superior nuchal line area generates front and back elevation of neck 109, to balance head.

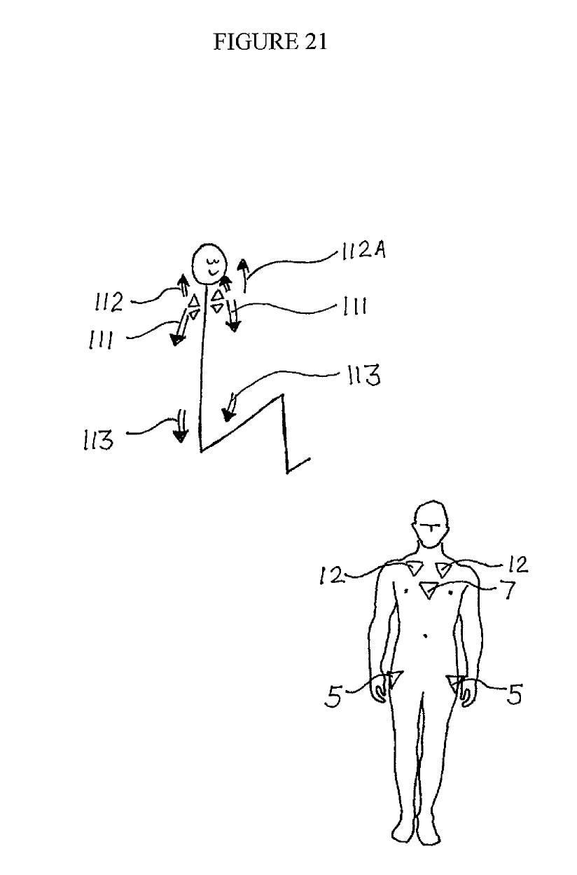

Contact Point 12: Collarbone, FIG. 21.

This contact point is located on one or both of the collarbones. Any use of straps to contact these points should not touch the musculature in the area. The use of this contact point #12, by itself or in synergy with Contact Point #7, allows an expansion of energy 111, 112, and lifting of the head 112A, and more natural swallowing. Contact Point #12 generates: postural energy flow in the back of the body, which elevates the chest 111, 112, and head 112A, while producing a natural anti-gravity response of the sitting bones 113, creating a synergistic stabilizing posture with contact point #5. Thus the head naturally sustains forward head positions, such as used for desk work, eating and speaking.

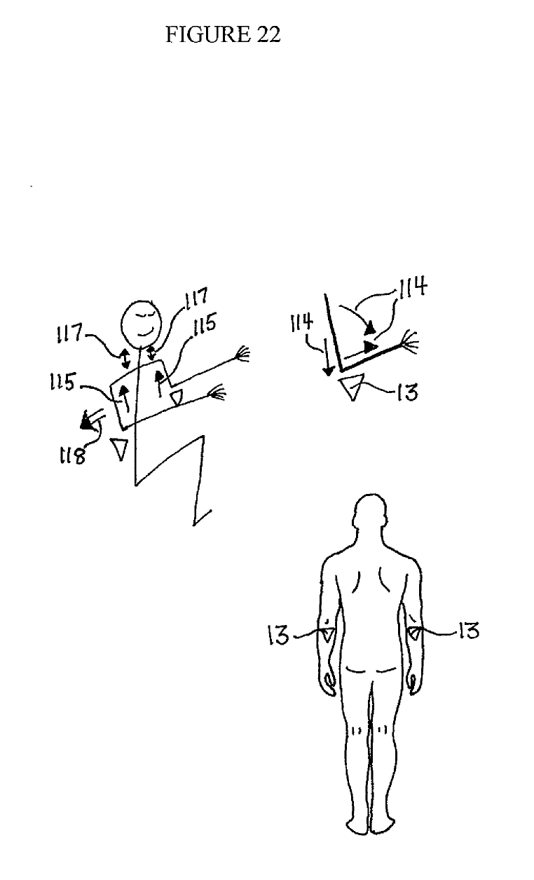

Contact Point 13: Elbow, FIG. 22.

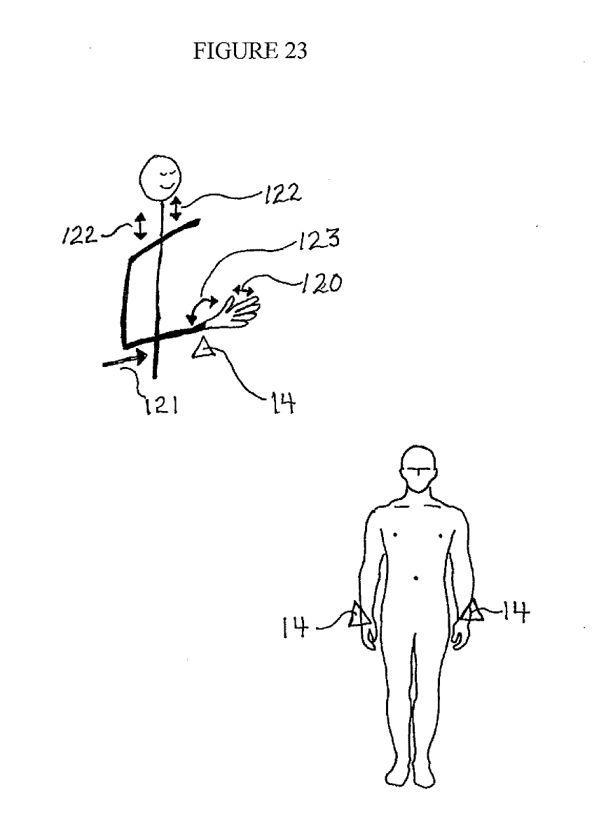

These contact points are located about 1-2 inches under each elbow. Only a gentle touch is required at this contact point, which can be achieved by the use of a set of shoulder straps providing only light contact (i.e., not resting strap). The shoulder must be allowed to relax freely or its natural resting position. The use of these contact points allows greater arm control and head/neck stability 117, as well as shoulder control. Contact Point #13 generates postural energetic flow to midback area 118, which allows extension of forearm 114, relaxation of shoulder 115. The synergistic effect of contact point #13 with contact point #14 wrist allows rotation of the hand and increases finger dexterity FIG. 23.

Contact Point 14: Wrist, FIG. 23.

This contact point is located one inch medially of the prominent bone of the wrist, and the underside of an inverted palm. Only a gentle touch is required at this contact point, which can be achieved by the use of a set of shoulder straps providing only light contact (i.e. not resting strap). Pressure at Contact Point #14 is often used in combination with Contact Point #13. The use of the wrist contact points generates energy flow for greater dexterity for grasping 120, increased wrist rotation 123, and spontaneous reaching/grasping 120, 121, and uplifting of shoulders 122, as the postural benefits from the shoulder harness increase arm control and head/neck stability.

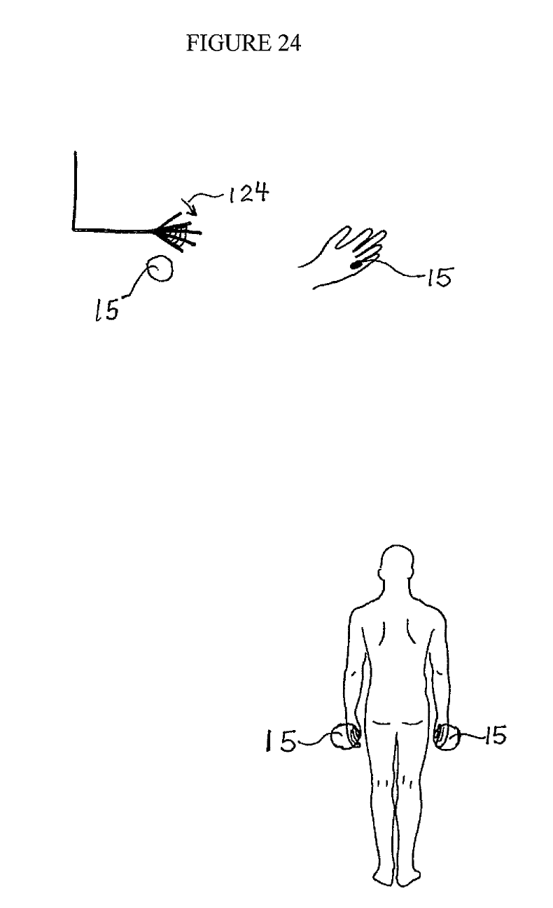

Contact Point 15: Small Finger, FIG. 24.

This contact point is located on the inside of small finger, at approximately between second digit. This contact point is particularly useful with walking devices, such as crutches, or the use of service dogs or other service animals. Contact Point 15 generates postural energy flow which stimulates the retraction of the corresponding thumb 124. Also, with extension of the pinkie the ipsilateral arm is more easily moved to extension and to follow the direction of the pinkie. This energy flow response allows for the effortless grip of the walking harness and the synergetic effect with CP#7 which can spontaneously stimulate and allow natural walking posture to be generated by a service dog or similar designed device by the inventor.

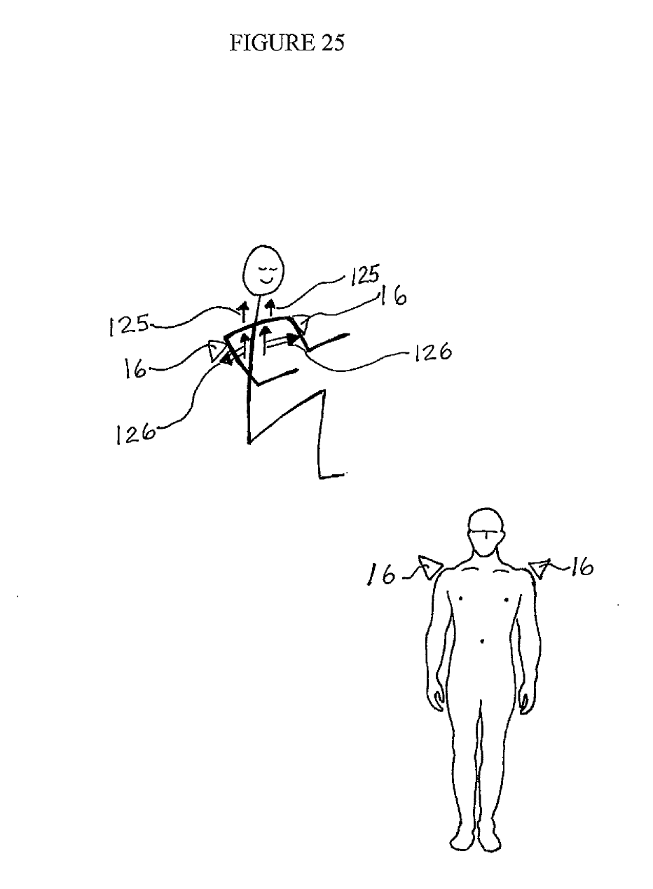

Contact Point 16: Shoulder, FIG. 25.

This contact point is located at the outside center of the shoulder, just below the top of the rotator cuff. For most individuals, this point is about one inch below the top of the rotator cuff. Contact Point 16 generates postural energy flow which stimulates elevation of the spine within the neck 125. Contact Point 16 also initiates energy to open the back between the shoulder blades 126, increasing stability and motor control.

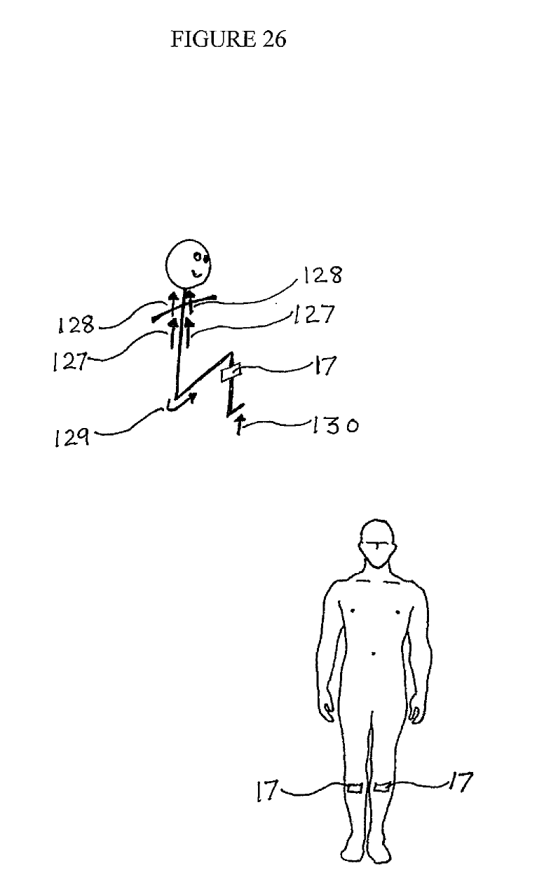

Contact Point 17: Below Knee, FIG. 26.

This contact point is located 2-3″ below the patella of the knee on the center of the leg. Use of this Contact Point, particularly in synergy with Contact Points #7 & 10, creates an upright standing ability. Contact Point 17 stabilizes the knee better than contact directly on the patella. It is important that this contact point, as with the other contact points, allow room for the person to move freely in an unrestrained manner. Contact Point #17 generates postural energy flow which stimulates upright spinal elevation lifting the chest 127, shoulders and head 128, by simultaneously and synergistically activating the sacrum to generate energy which extends downward 129, and to include energy activation of the balls of the feet 130.

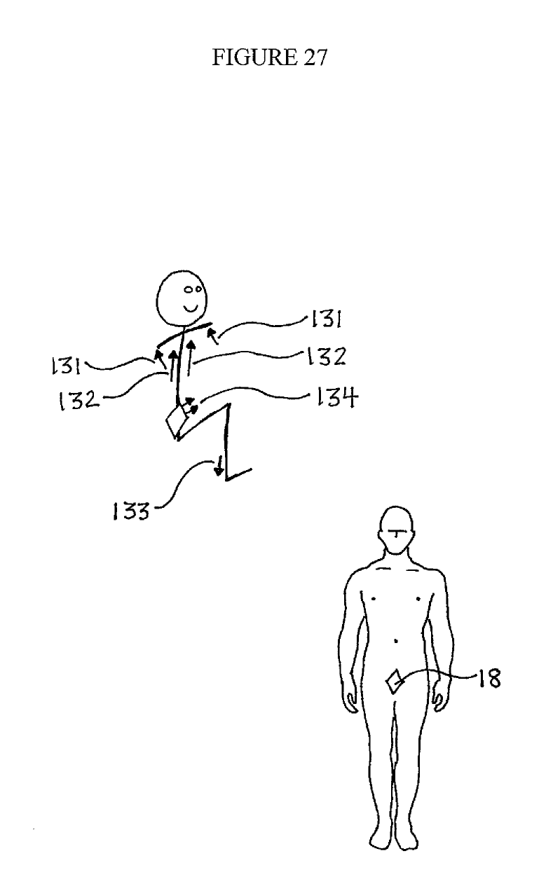

Contact Point 18: Pelvic Bone, FIG. 27.

This contact point is located just above the pubic bone, with a slight contact of the pubic bone. Contact with this point triggers uprightness at the shoulders. Contact Point 18 generates postural energy flow which stimulates the elevation of the shoulders 131, and extension of the spinal neck 132, while simultaneously generating a downward energy flow at the heels 133, and activation of pelvic core muscles 134.

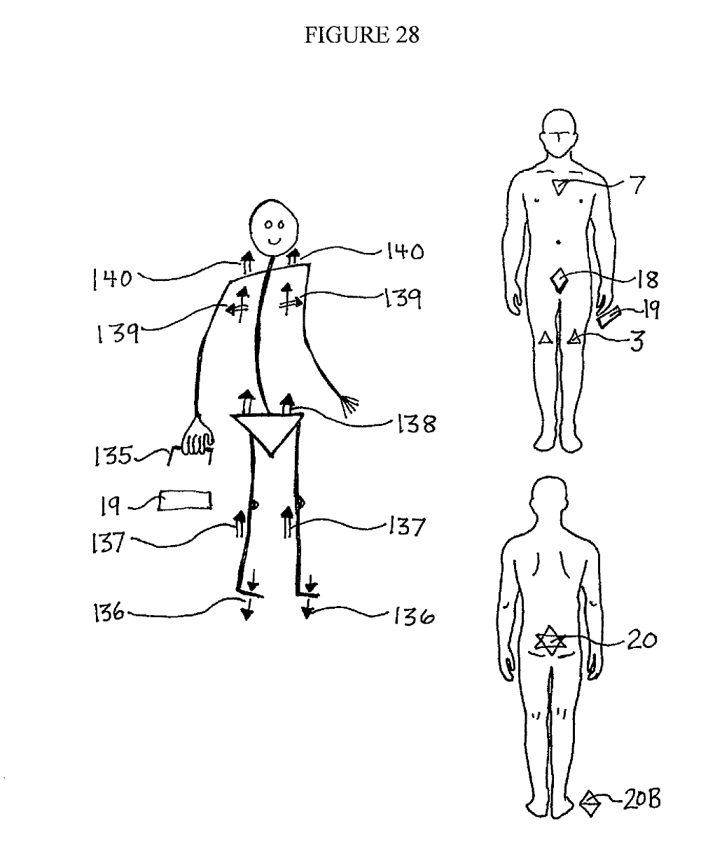

Contact Point 19: Synergistic Posture Balance, FIG. 28.

This Standing finger contact point #19 is located on the palm of the 4 fingers at the intermediate phalanges when slightly flexed to maintain contact with a standing (to be used as walking) handle. This handle is positioned so the ipsilateral arm has relaxed extension. The individual is able to maintain an upright position for standing, aided where the natural postural effect is unimpediated. A direct contact with the handle 135, generated from the correct pressure and natural stance will allow the synergistic effect of the primary Contact Points; #18, #7, #3, #20. Contact Point #19 generates postural energy flow which stimulates increased sensory awareness of underside of feet 136, increasing an upright effect through the calls 137, on the body to straighten 138, which generates elevation of the upper body and head 139, further triggering a forward facing posture of the head 140.

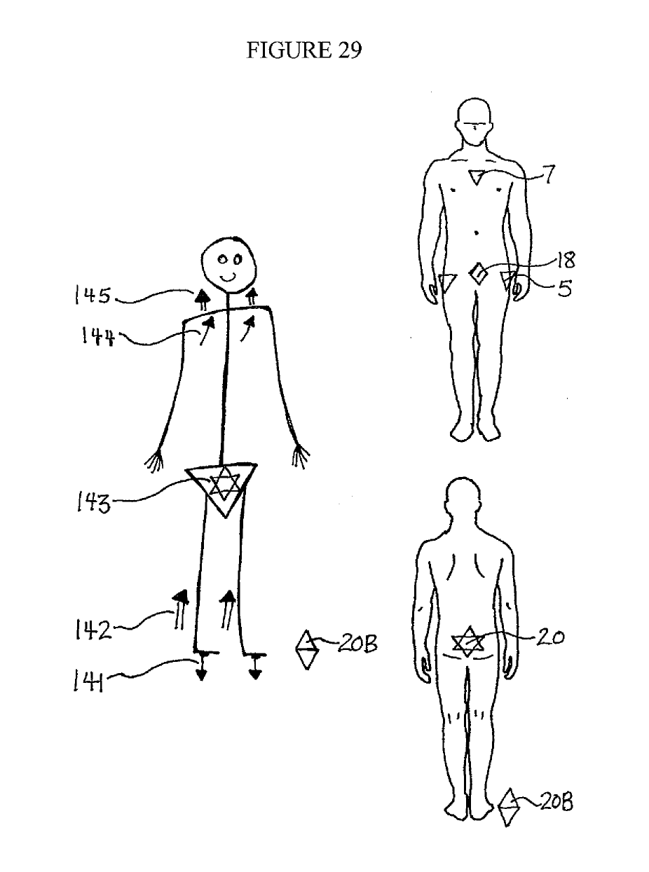

Contact Point 20B: Plantar Metatarsus and Tail Bone. FIG. 29.

Contact Point #20B is located on the plantar surface, just behind the balls of each foot. This contact point is activated during standing, walking, sitting or lying with ankle retraction CP#10. Contact Point #20B generates postural energy flow which stimulates increased sensory awareness of underside of feet 141, increasing an upright effect through the calfs on the body to straighten 142, focusing energy flow in the tailbone area 143, activating CP#5, CP#18 and continues upward activating chest area 144, surrounding CP#7, uplifting the head 145, so the natural posture generated feels light yet stable.

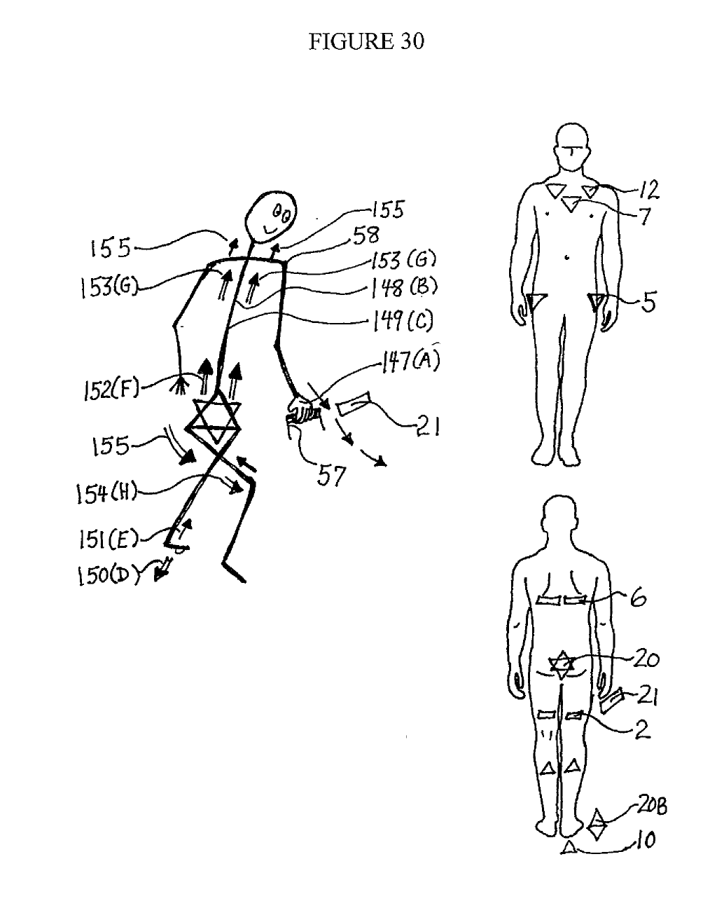

Contact Point 21: Synergistic Dynamic Balance, FIG. 30.

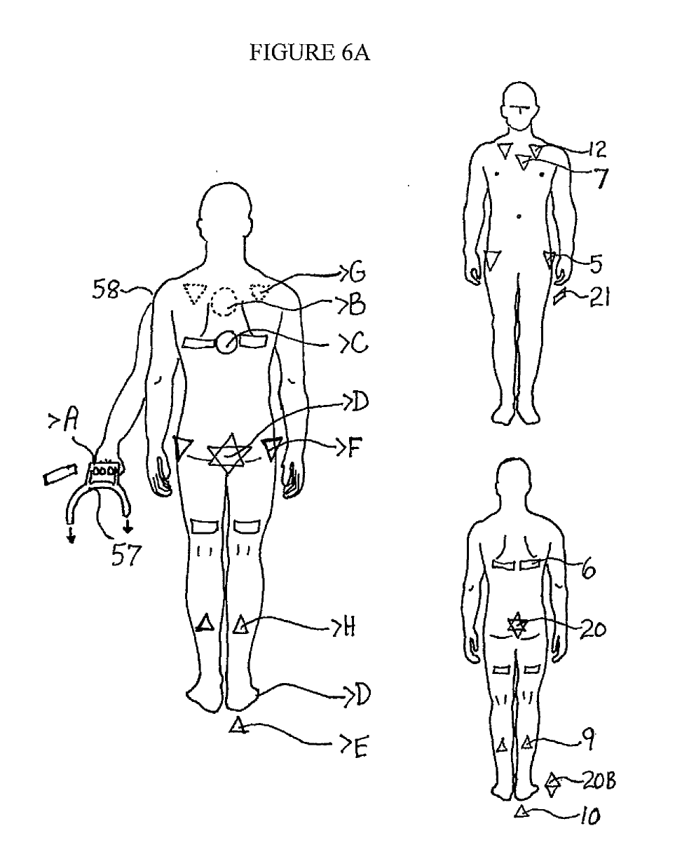

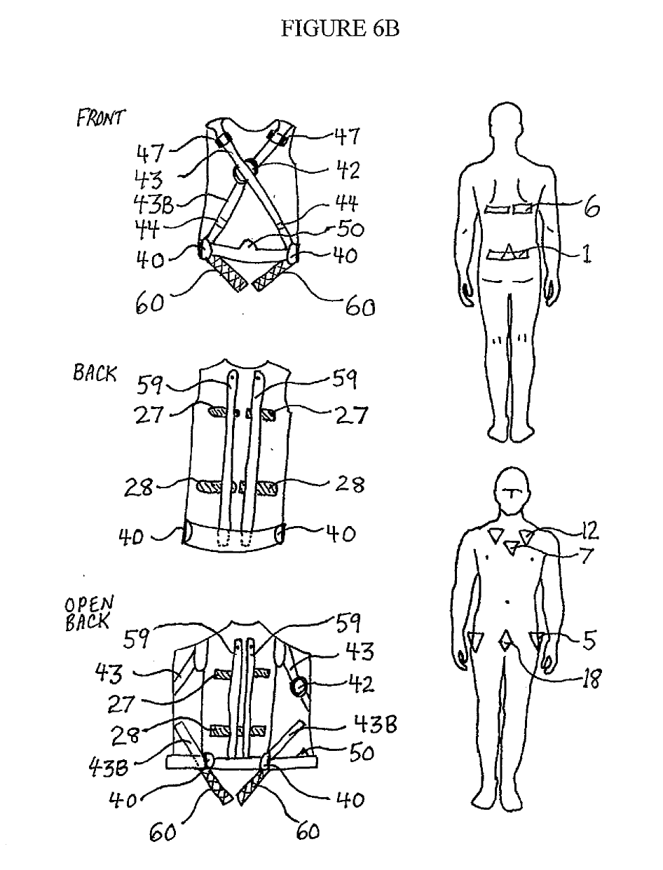

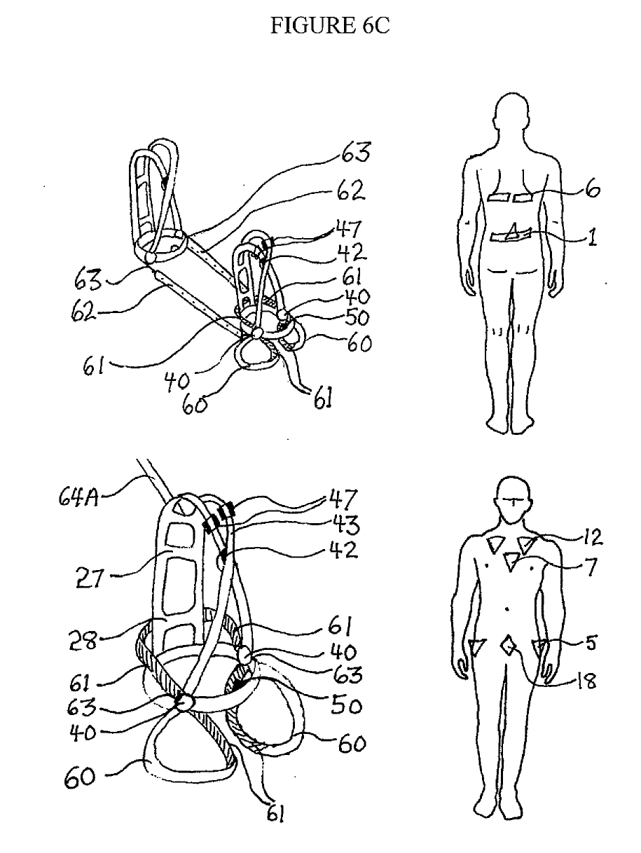

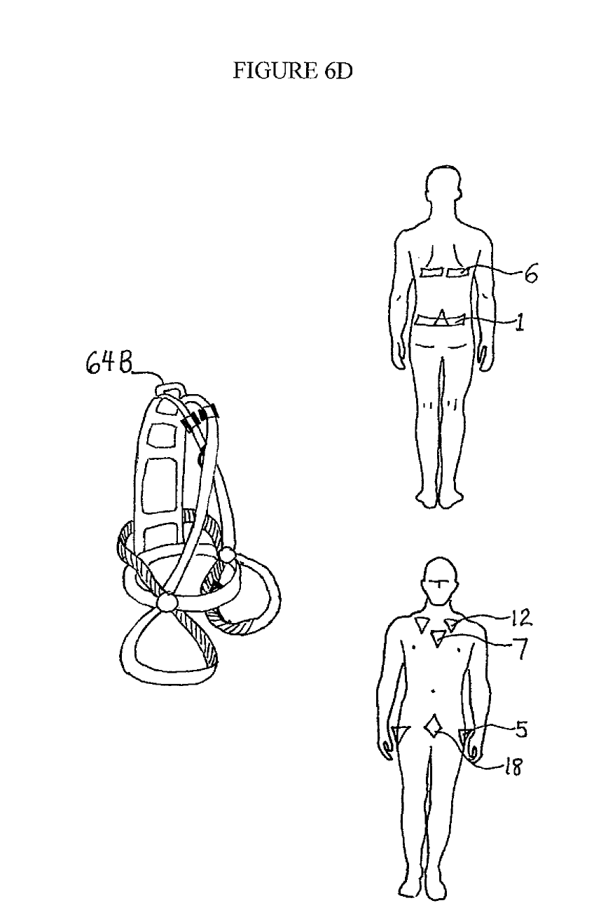

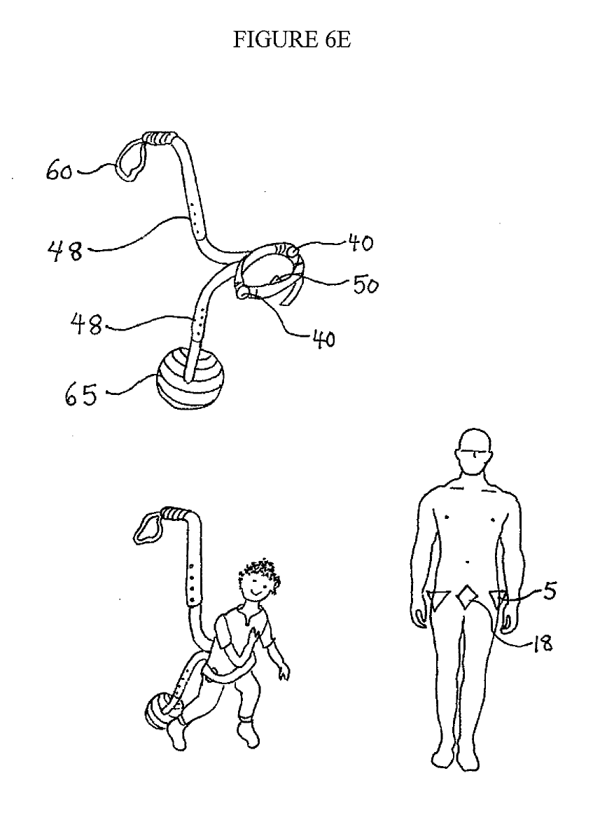

This Dynamic Finger Walking contact point #21 is located on the palm of the 4 fingers at the intermediate phalanges when slightly flexed to maintain contact with a walking handle. This handle is positioned so the ipsilateral arm has relaxed extension. The individual is able to maintain an upright position for walking, aided where the natural postural effect is unimpediated. A pulsing contact with the handle generated from the correct pressure and gait (walking) pattern allow the synergistic effect of the primary contact points; #18, #7, #10, #3, #20. Contact Point #21 generates postural energy flow which stimulates gait patterns of walking and jogging detailed in Application FIG. 6A. Summarized here is the complete synergetic effect of walking contact point #21. The handle 57, is positioned to initiate and maintain a shoulder angle 58, range of 40 degrees to 45 degrees producing a more dynamic natural upright walking posture, which demonstrates the actual synergistic effect to energize stepping when stimulating only finger contact points #21, while initiating one's body upright for this activity. The energy cycles, averaging 1 to 3 seconds through all identified contact points, starting with walking finger points #21 marked 147 (A), to sternum point #7 marked 148 (B), to midback point #6 marked 149 (C), to plantar metatarsus point #20B marked 150 (D), to ankle flexion point #10 marked 151 (E), to hip point #5 marked 152 (F), to midback point #6 marked 149 (C), to sternum point #7 marked 148 (B), to collar bone points #12 marked 153(G), to hip points #5 marked 152 (F), to plantar metatarsus point #20B marked 150 (D), to ankle flexion point #10 marked 151 (E), to underthigh point #2 marked 154 (H), to hip points #5 marked 152 (F), to trigger stepping 155. This cycle repeats spontaneously and continuously with intermittent stimulation of finger contact. This synergistic effect may also extend to, but is not limited to, initiate dancing, jogging, running, climbing, or stairs up/down.

The above contact points, or postural points, act as rest points, from where an upright, correct posture is stimulated and evoked subconsciously (without conscious effort). The interaction of one or more of the following contact points facilitates the body's own natural mechanisms for upright stability. This is accomplished by specific positioning the skeletal body, and by using light pressure on the correct combination of one or more skeletal contact points. The result is an increased freedom/range of movement. Use of these contact points creates a very postural stable base, even when outside force or pressure is applied from any direction.

The optimal usage of these contact points may require daily use, with an accumulation of a minimum of 3-4 hours per day, for at least 20 minutes duration of unconscious, spontaneous training intervals. Experience with several subjects indicates that at least 2 hours accumulated per day minimum use of these contact points are required for long term benefit. Additional contact time may be required due to physical conditions, job requirements, physical condition and/or other parameters. Because the stimulation of these contact points can generate considerable energy flow and synergistic postural effects, it is important to carefully monitor the contact point applications and positioning when first fitting those individuals with very limited range of motion. A correct combination of the contact points is required for different activities, such as during meals, school activities, computer stations, and recreational devices, etc. The beneficial effects are immediate, accumulative, and residual, gained from the repeated usage of this system.

The present system consists of the use of one or more of the above described contact points in a posture system or device. A preferred embodiment is a posture system that uses a plurality of contact surfaces to provide pressure to a plurality of contact points as appropriate for the individual in a synergistic method.

Posture systems or devices utilizing this invention can consist of school chairs, office chairs, chairs, walkers, crawlers, stools, tricycles, motorcycles, kayaks, canoes, auto or bus seats, riding saddles, devices for sit-skiing, wheelchairs, easychairs, beds, hammocks, service animals, booster seats, wearing devices, ultra lights, sport racing suits and many other similar systems. Several examples of preferred embodiments are illustrated below.

Seating Devices:

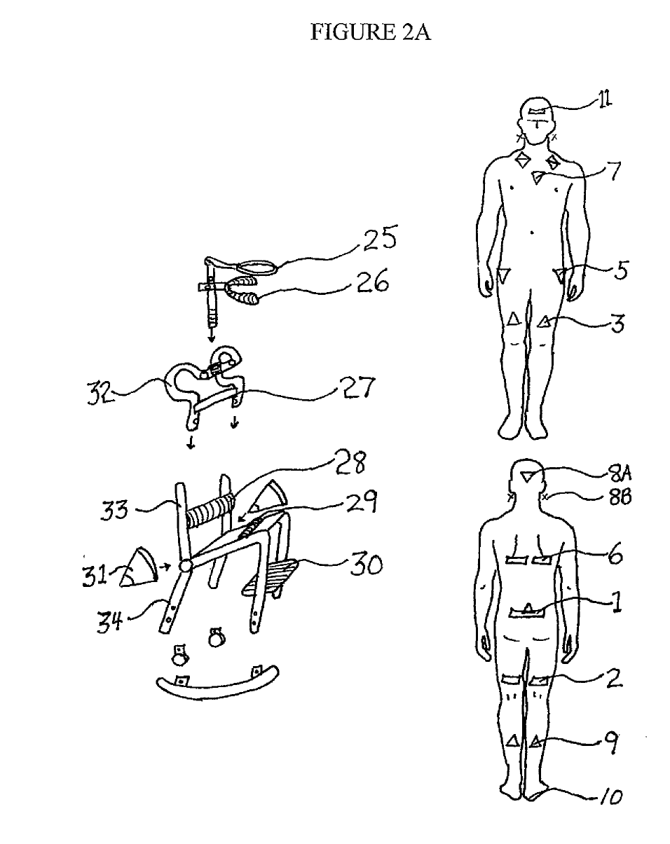

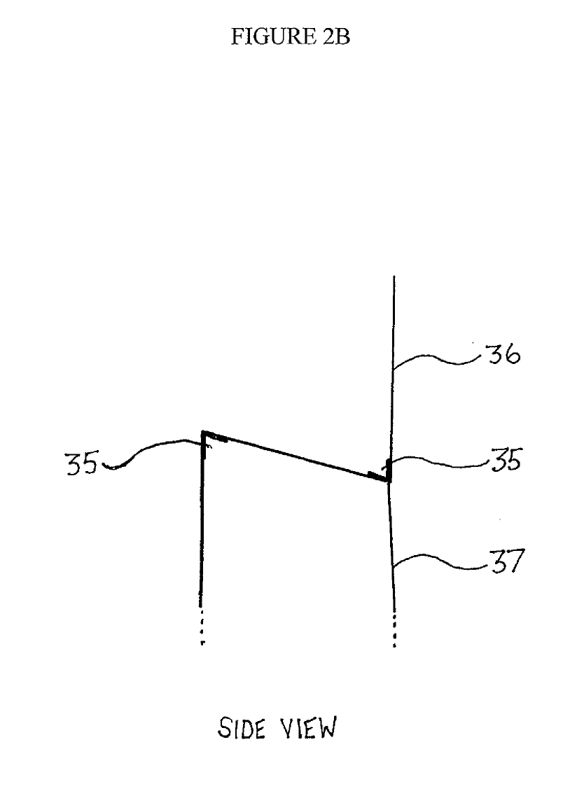

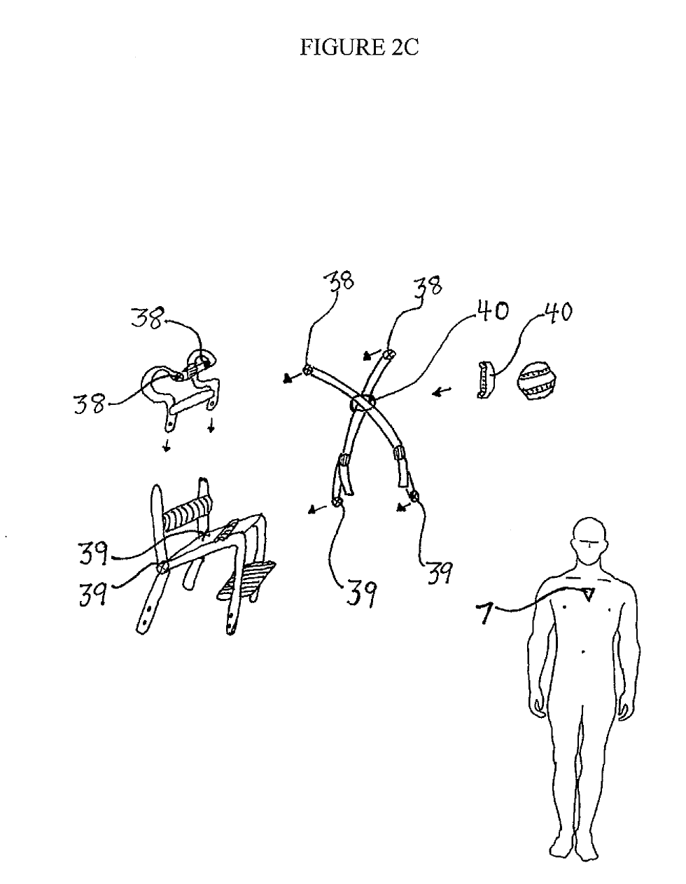

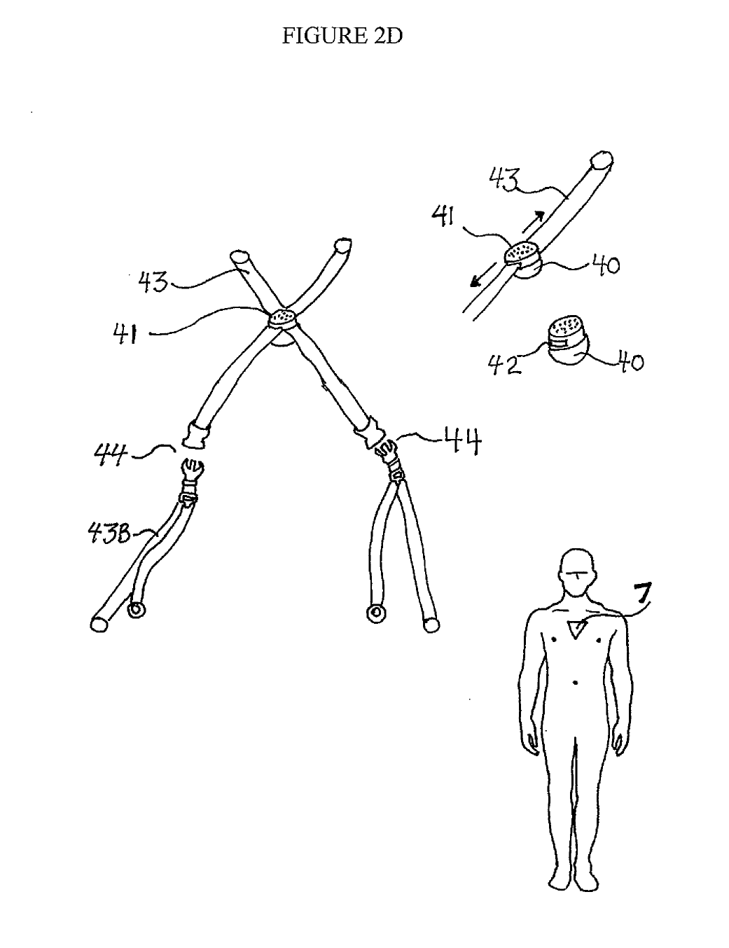

Any seating device such as a chair, rocker, or wheelchair can be designed or modified to incorporate one or more contact points. The typical features of seating devices according to a preferred embodiment of the present application are illustrated in FIG. 2A. Typical embodiments, illustrated in FIG. 2B include a seat angle of between 70 and 76 degrees, with a preferred angle of 73 degrees and includes a plurality of contact surfaces for providing constant intermittent pressure to contact points of the user, at the back of the thighs 2, upper back 6, lower back 1, hips 5 and feet 4. This seating device comprises at least eight adjustable elements: namely, chair leg height 34; height of foot rest 30; angle of foot rest; width between hip pads 31; position of under-thigh pad on seat 29; height of lower back strap 28; height of upper back strap 27; and height of top bar 32. The adjustability of the device allows it to be customized to fit various users. Optionally, the adjustability can permit the user to remove one or more of the plurality of contact surfaces.

FIG. 2A also illustrates Back legs 34 inclined for stability and back posts 33 inclined for postural effect. The use of a small under thigh pad 29, (contact point 2) as well as side hip pads 31, (contact point 5). A low back strap 28 is used (contact point 1) and foot plate 30 to cross legs (contact point 9) The foot plate 30 which is angled to between 70 and 80 degrees, with a preferred angle of 75 degrees (contact point 10). Attached to the top of the seating device is a higher back part which incorporates a mid-back strap 27 (contact point 6) and possible handles 32 for moving the seating device such as a wheel chair. A device attaches to the top of the higher back posts 32, which utilizes a head rest 26 (contact point 8A & 8B) for the back of the head, as well as a forehead strap 25 (contact point 11). Typical embodiments, illustrated in FIG. 2B include a seat angle of between 70 and 76 degrees, with a preferred angle of 73 degrees 35, (contact point 3). Also Back legs of seating device inclined 37, by 3 degrees and back posts of seating device inclined 36, by 3 degrees. Finally, a cross chest strap device can be utilized as attached to the seat intersection with back 39, and higher Back part 38, which provides a pad 40, for resting on the sternum (contact point 7), illustrated in FIG. 2C. Greater detail of this cross sternum device is shown in FIG. 2D, where the sternum pad 40, is affixed to a plastic disc 41, with a gap 42, sufficient to allow the nylon strapping 43, to slide to a position, which is held in place by Velcro. Adjustability is provided by the lower nylon strapping 43B, and clips 44, for easy access to fit when seated.

Seating devices which are typical to the present invention can utilize all of the contact point features described above, or a lesser amount, resulting in at least one or more contact points. Designs of modular seating devices can be made specific to individual user's requirements, where certain contact points may provide greater benefit than other contact points. FIG. 2C shows modular components of the present invention, which can include the Cross Sternum Support FIG. 2D.

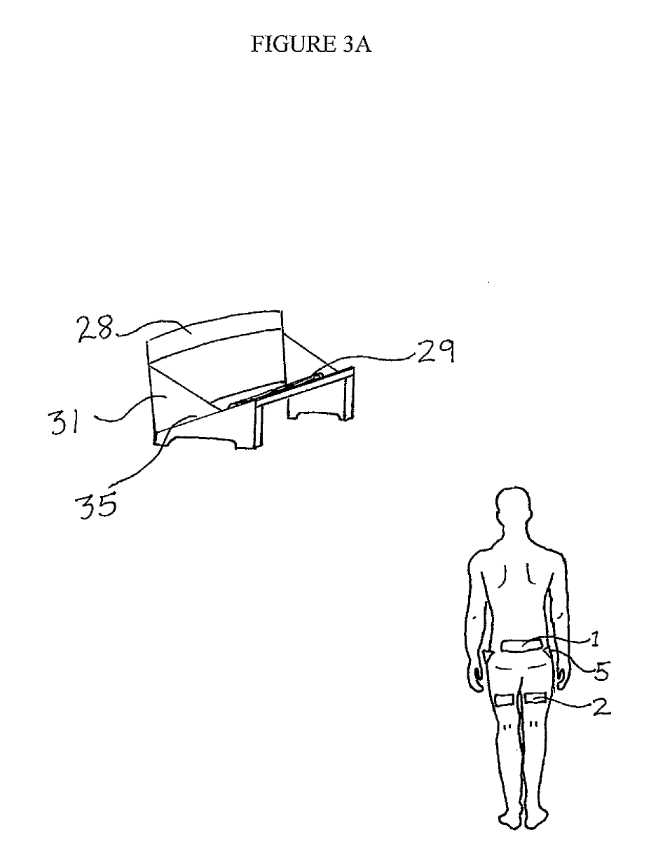

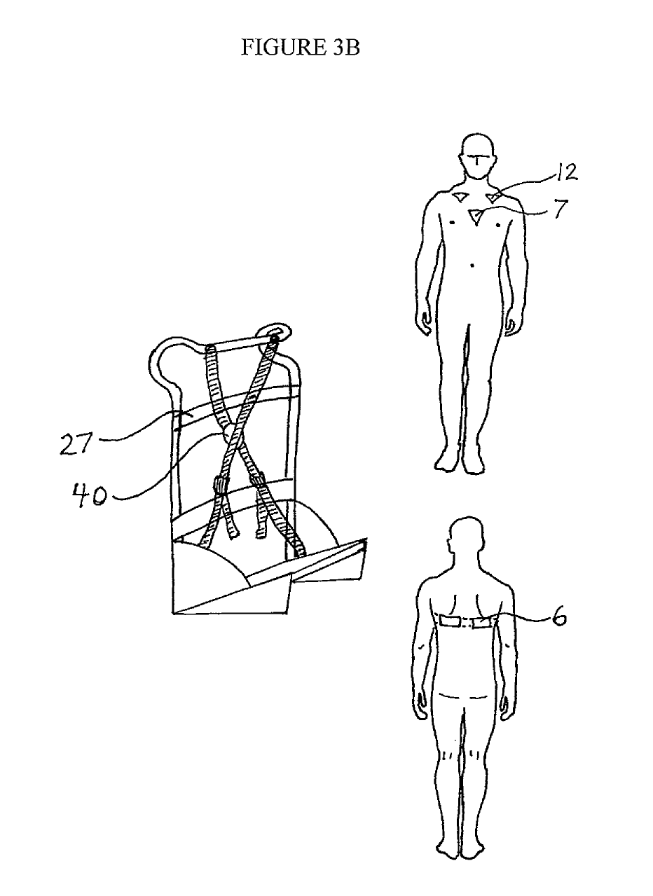

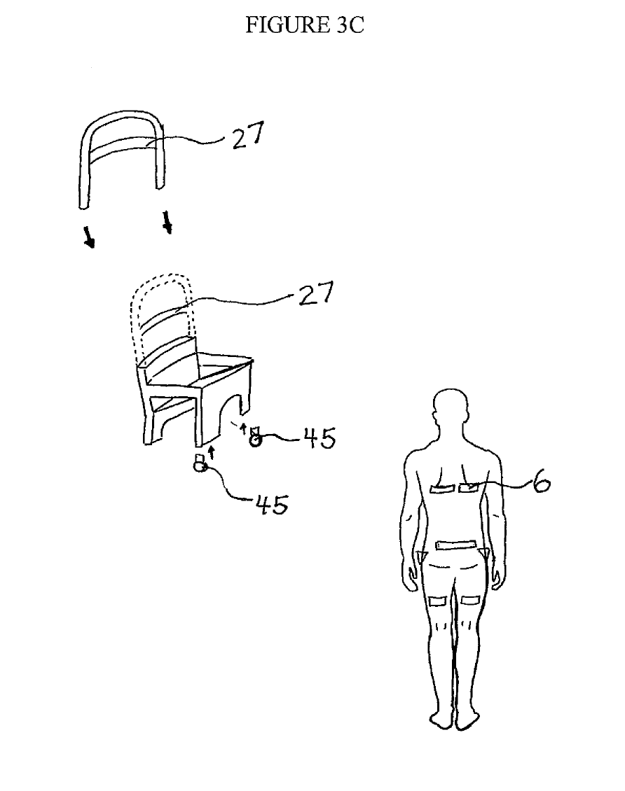

Seating devices such as chairs can be designed in different sizes to accommodate school children up to large adults, with a resulting safe and balanced center of gravity. Features of contact point system chairs include: i). adjustable for each individual user to ensure a precise fitting against each contact point; ii) the capacity for all contact points to be used in a chair through the addition of various attachments, iii.) additional feature of collapsibility to ease transport. Modified chairs can include rocking chairs, with the addition of wedges on the rocker surface to inhibit the range of rocking in order to ensure stability of use. A stool or low chair can be designed which potentially utilizes casters for movement, as shown in FIG. 3A, 3B, 3C. These stools, chairs and walkers could be constructed of waterproof materials, such as plastic or webbings, in order to allow use in a water environment, such as showers, baths or pools. FIG. 3A is a basic booster postural seat, with a low back strap 28 for contact point 1, hip pads 31 for contact point 5, angled seat platform 35, underthy pad 29 for contact point 2. FIG. 3B provides for additional postural support to the basic booster of a mid back strap 27 for contact point 6 and 12 and also sternum cross pad 40 with straps for contact point 7. FIG. 3C shows the attachable upper back frame with mid back strap 27, for contact point 6 and attachable caster wheels for mobility to a basic booster postural seat.

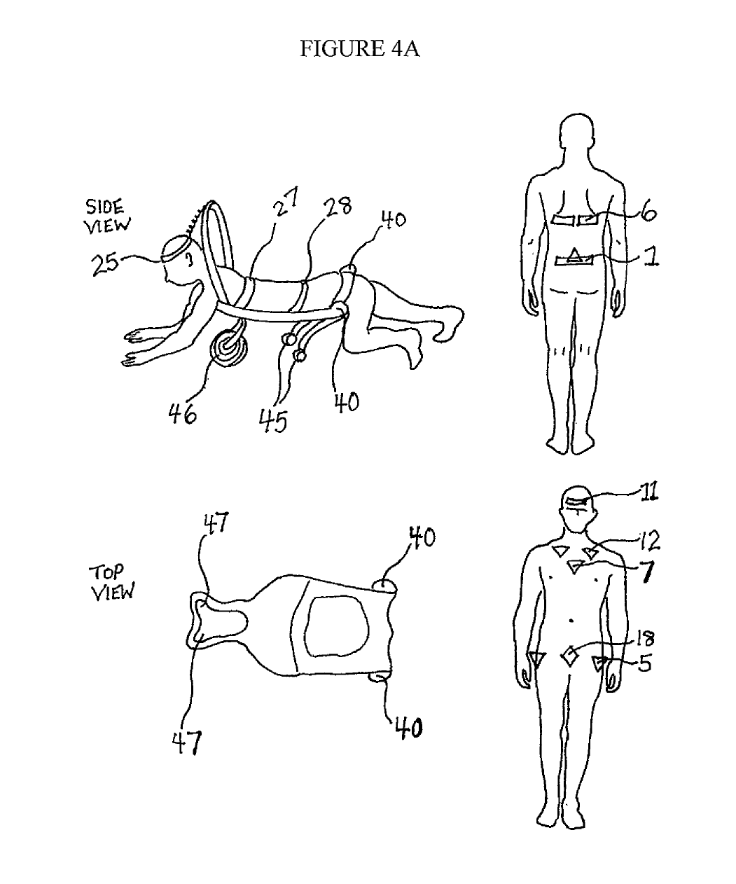

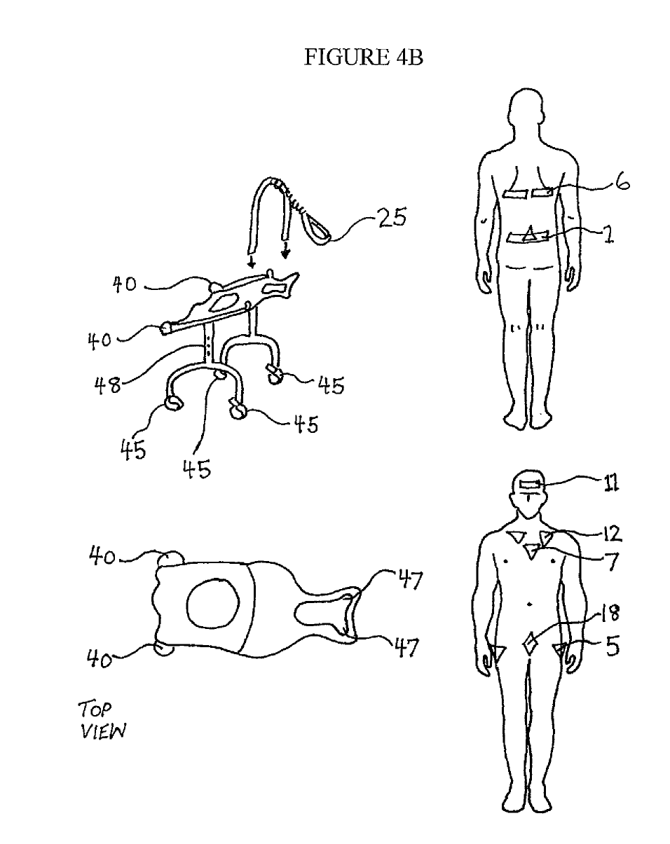

Crawlers are designed to incorporate many of these contact points #7, 6, 2, 12, 5, 18, 11. The basic toddler/child crawler FIG. 4A allows for natural crawling motion, arms-free exploration and an elastic tethered head strap 25 is available for hand eye coordination. The sternum contact point #7 is connected to the ground through a ball wheel 46 and the hip pads 40 for contact points #5 are directly connected to the ground through two supporting casters 45. A low back elastic strap 28 for contact point 1 and a mid back elastic strap 27 for contact point 6 also stimulate posture. Neoprene pads 47 stimulate contact point 12 for freer arm action. Low Bench Crawler FIG. 4B is designed for larger children, teens and adults for school activities, work duties and leisure tasks who require arms free manipulation and dexterity and simultaneous independent use of legs for repositioning or relocating. Elastic tethered head strap 25 for contact point 11 and the low back contact point 1 is the pivot connection to the ground by the tubing 48. Swivel casters 45 and hip pads 40 for contact point 5 enable effortless postural motion. Padded neoprene 47 stimulates contact points 7 and 12. The Postural Vest (FIG. 6B) could be worn while using the low bench crawler if the individual needs to get on and off repeatedly.

Walking Devices:

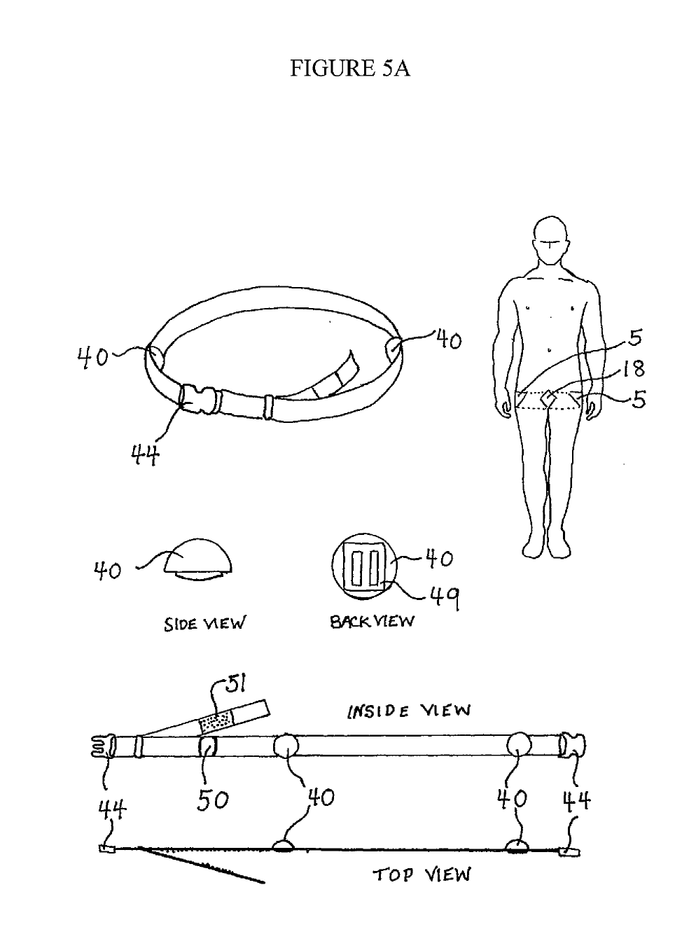

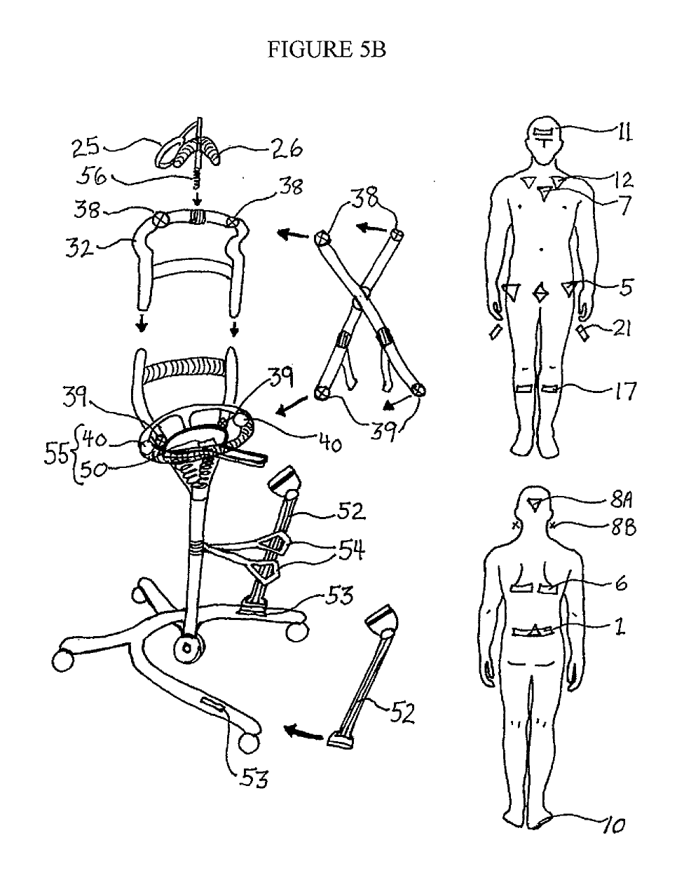

The contact point system can be incorporated into pre-existing walker devices or into custom designed walkers, as illustrated in FIG. 5B. Important embodiments of present invention, which are not previously described in FIG. 2A or 2C and FIG. 5B include the use of a hip/pelvic strap illustrated in FIG. 5A for contact points 5 & 18. FIG. 5A details the belt (inside view) has a dense foam half ball pad 40 with a plastic clip 49 on the flat side to secure them to the belt for each hip contact point 5. There is a half inch dense flat foam pad 50 afixed on the belt for pelvic contact point 18. The belt is fitted for circumference by adjusting the Velcro 51, then fastened in place with the clip 44. Illustrated in FIG. 5B are removable 53, alternate walking handles 52 for fingers walking contact point 21 and knee stabilizer straps 54 for contact points 17. Also, an attachable 38, 39, cross sternum device FIG. 2D for contact points 7 & 12 may or may not be used depending on the required benefits of the individual user. Finally, to the top of the higher back posts 32, which connects a spring post 56, head rest 26 for contact point 8A & 8B for the back of the head, as well as a forehead strap 25 for contact point 11. FIG. 5B shows a strap device 55, to make hip contact 40 at contact points 5 and pelvic contact 50 at contact point 18, and may be used alone or in combination with a walking device.

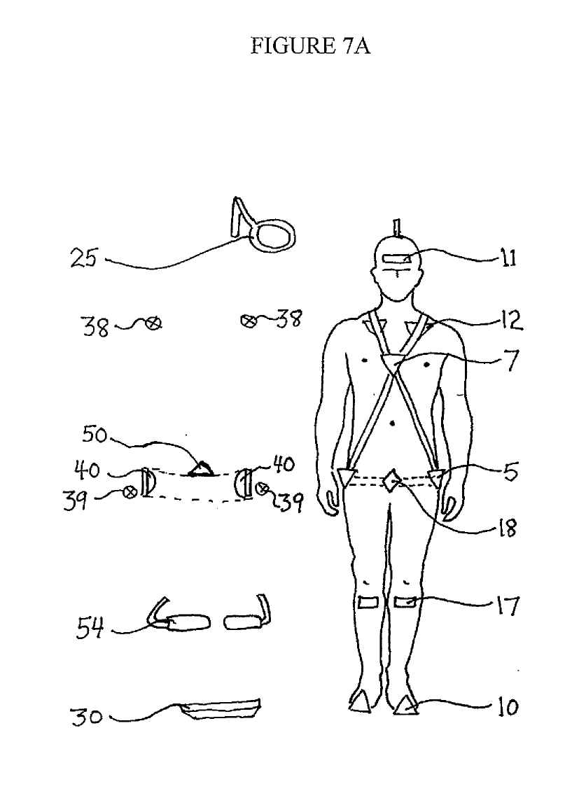

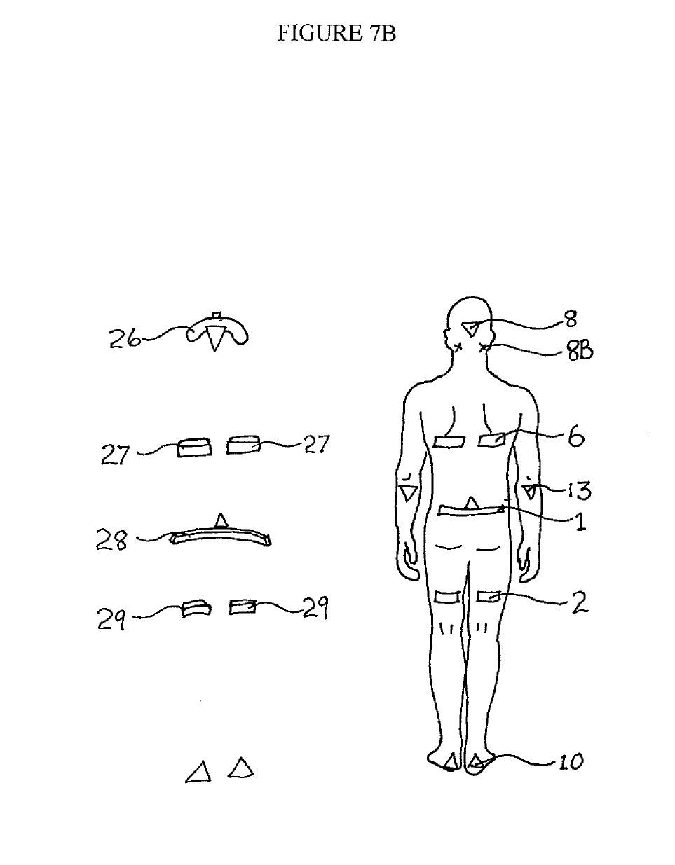

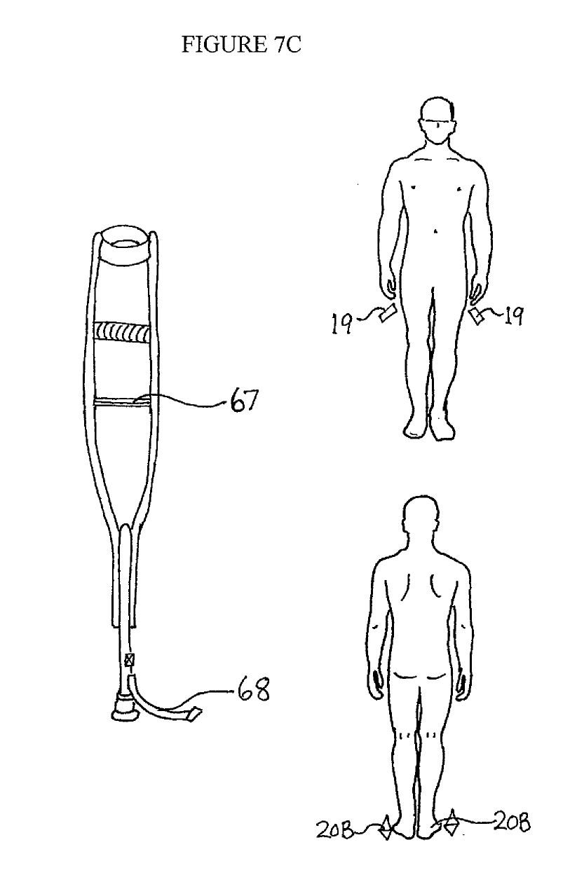

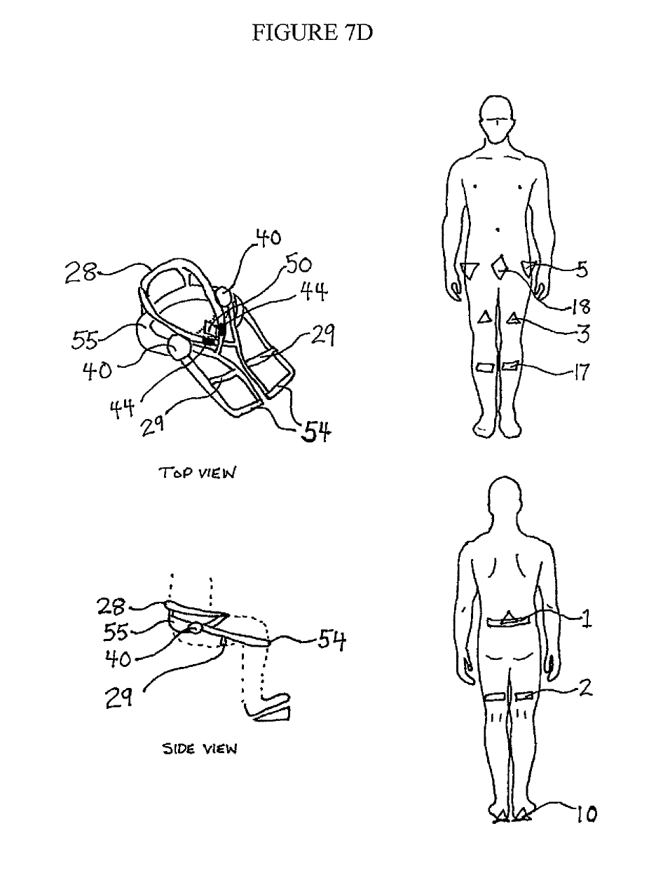

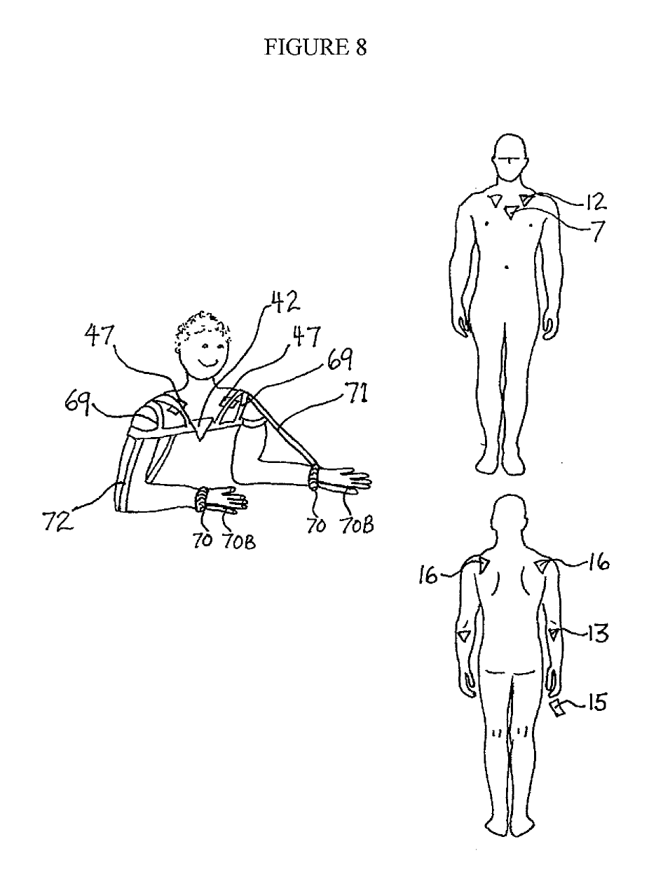

A postural vest illustrated in FIG. 6B can be used for all daily or leisure activities, including lying down and sitting. It can be used for postural training, recovery and maintenance for many conditions, including but not limited to cerebral palsy, stroke, movement disorders or back injuries. The postural vest FIG. 6B is custom-measured and made for all ages. The material is light weight, breathable, and incorporates cross sternum straps 43, 43B, positioning sternum pad 42 for contact point #7, and collarbone pads 47 for contact point #12. The pelvic pad 50 for contact point #18, hip belt pads 40 for contact point #5, upper back pads 27 for contact point #6, and lower back pads 28 for contact point #1. The upper leg thy straps 60 position and secure the postural vest in place during activity and the back inflatable inner tubes 59 apply the firmness to stabilize contact points #1, 6. The postural vest may be used independently or with these inventions; low seating (FIG. 3A), low bench crawler (FIG. 4A) when an individual is able to get on and off the bench crawler or needs additional contact support for working such as carpentry, plumbing, machinery, hip joint/pelvic strap (FIG. 5A), standing walkers—without back and head supports (FIG. 5B), service animal walking application (FIG. 6A), toddler walker (FIG. 6E), crutches (FIG. 7C), sitting harness (FIG. 7D), arm/hands free control (FIG. 8A). The postural vest may be used in all other stationary or mobility situations with existing apparatus as recommended beneficial such as in, but not limited to swimming, bicycling, running, gardening, driving, canoeing, motorcycling, scuba diving, jet ski, and traveling. The contact point design could be incorporated into a lifejacket for hydro-therapeutic or recreational use.

Team-supported walking devices harnesses (FIGS. 6C and 6D) is designed for a parent, guardian, sports trainer, physiotherapist, occupational therapist, to assist in the gait-development of a child or youth. Such a harness system FIG. 6C would include a harness for each of the parent/guardian and the child, with two ridged guide cables, hip to hip 62 connecting the two harnesses with swivel clips 63 to the hip belt underneath the hip pads 40 on both sides, which is also clipped to the low back to hip ipsilateral leg straps 61 to secure the child harness in place. and there is one sternum to highback strap 64A. Such a system would facilitate the child to ‘feel’ (kinesthetic proprioception) natural body posture and movements of the adult through several contact points #7, 12, 18, 5, 6, 1, thus enabling the child to make more natural movements. The team harness would provide natural trunk stability from the upper cross sternum straps' 43, collor bone pads 47 for contact point #12 and sternum pad 42 for contact point #7, low back strap pad 28 for contact point #1, mid back strap pad 27 for contact point #6 this stimulation, thereby allowing more motor control, coordination and development of the arms, legs and head. This harness system would be fully adjustable. The team-supported system could be used by individuals with low muscle tone conditions, motor planning issues, blindness, or injuries which result in these conditions. Team support Toddler walking harness FIG. 6D is a more compact portable system which provides stimulation to the same contact points #6, 1, 12, 7, 5, 18, as in FIG. 6C, however the assistance is provided by an upper high back handle 64B. Also in FIG. 6E a Toddler Walker shows how the child can use the hands-free beginner Walker, stimulating natural balance/posture for exploration. This rigid walker FIG. 6E enables the parents to maintain more safety with a wrist safety strap 66 and with the hip belt pelvic pad 50 for contact point #18 and hip foam pads 40 for contact points #5. Also the large (5″ diameter) dynamic, stabilizing caster ball provides parents with a unique guiding method, rather than, grasping their hand/arms above their heads.

Kayak/Canoe/Saddle Devices:

As shown in FIG. 3A the embodiment would be an apparatus that could be built into the structure of the seat (i.e. a customized seat for a Kayak), or it could be attached on to the top of the existing seat (i.e. as for a canoe). A saddle could be adapted in a similar way to utilize a postural apparatus with more than one contact point, preferably a minimum of four contact surfaces, low back strap 28 for contact point #1, underthigh pad 29 for contact point #2, hip side pads 31 for hip contact points #5, and seat angle 35. Similarly, the application of basic postural plus trunk contact in FIG. 3B includes contact surfaces; mid-back strap for contact point #6, and cross straps for 40 sternum point #7. Flotation devices can easily be attached to the back of the back support for safety.

Service Animals, Crutches and Wearing Devices for Sitting or Walking:

Both the postural vest FIG. 6B can be worn simultaneously to enhance natural upper body posture contact points #1, 5, 6, 7, 18, 12 and/or the hip joint/pelvic strap FIG. 5A may be worn simultaneously for increased stability by stimulating contact points #5 and #18, while using the service dog handle 57, FIG. 6A to enhance the synergetic effect of spontaneous natural posture while initiating and maintaining walking.

The application of this invention in FIG. 6A when utilizing a service dog with harness handle 57, to initiate and maintain a shoulder angle 58, range of 40 degrees to 45 degrees for a more dynamic natural upright walking posture demonstrates the actual synergistic effect to energize stepping when stimulating only finger contact points #21, while initiating one's body upright for this activity. The energy cycles, averaging 1 to 3 seconds through all identified contact points, starting with walking finger points 21 marked as >A, to sternum point 7 marked as >B, to midback point 6 marked as >C, to plantar metatarsus point 20B marked as >D, to ankle flexion point 10 marked as >E, to hip point 5 marked as >F, to midback point 6 marked as >C, to sternum point 7 marked as >B, to collar bone points 12 marked as >G, to hip point 5 marked as >F, to plantar metatarsus point 20/20 marked as >D, to ankle flexion point 10 marked as >E, to crossleg point 9 marked as >H, to hip point 5 marked as >F, to >stepping triggered, cycle repeats spontaneously and continuously with intermittent stimulation of finger contact point 21 marked as >A.

Crutches as shown in FIG. 7C can be either designed and built to utilize the contact point system, or contact surfaces can be added/modified to existing crutch designs as illustrated with these wooden forearm cuff crutches. Crutch modifications FIG. 7C would include on a pair of crutches, standing finger straps 67 for contact points standing fingers #19 and foot straps 68 for contact points plantar metatarsus #20B, which also hold crutches in correct position to simultaneously stimulate both #19 & #20B as indicated in FIG. 7C. A light upward pull on the finger strap 67, (contact point 19) induces automatic more steadiness of standing at the balls of the feet (contact point 20B), improving posture, balance, stability and relaxation while standing. This finger strap 67, functions on the same principle as in FIG. 6A standing with the service dog handle 57 device. The crutch foot strap 68 in FIG. 7C provides a counter resistance to the gentle upward pull on the finger strap 67.

Standing devices as shown in FIGS. 7A & 7B: Shows this inventions contact surfaces to be incorporated for a typical design for standing devices or parapodium devices, FIG. 7A, front view, incorporates head strap 25 for contact point 11, sternum cross strap attached at 38,39 for contact points #7, #12, hip belt hip pads 40 for contact points #5, and pelvic pad 50 for contact point #18, knee stabilizer pads 54 for contact points 17, angled foot plate 30 for contact point #10. FIG. 7B, back view, incorporates headrest 26 for contact points #8A, 8B, upper back pads 27 for contact points #6, lowback pad 28 for contact point #1, underthigh pads 29 for contact point #2, which can be added as required. The stimulation of these contact points will increase standing comfort and duration.

A wearing device, Sitting Harness, FIG. 7D is a lightweight, portable design for seating with but not limited to a unit of furniture, such as car or tractor seat or other device system, and can be used independently while hunting in a blind or tree, for assisted sitting which utilizes several contact surfaces to stimulate contact points #1, 2, 3, 5, 9, 10, 17 and 18. This sitting harness 7D would utilize contact surfaces low back strap 28 for low back contact point #1, underthigh elastic strap 29 for underthigh contact points #2, knee angle position contact point #3, hip belt 55, for hip pads 40 for contact points #5 and pelvic pad 50 for pelvic contact point #18, knee stabilizer strap 54 for contact points #17, and optional cross leg contact points #9, or heel angle contact point #10, as desired by user.

Arm/Hand Mobility Devices:

Arm support systems are designed using the contact point system, which are independent of chairs, walkers or other devices, but can be used in combination with these other devices for neck, spine, shoulder injuries, or stroke, etc. A modular unit shown in FIG. 8 is designed to aid an arm(s) with an injured shoulder(s) and an optional hand support, aid an arm(s) using a wrist strap and optional hand support, or hand support alone. Inherent in the shoulder harness 69 are clavicle pads 47 for contact points #12, and a sternum pad 42 for sternum contact point #7. The shoulder harness would provide two downward elastic straps 72 on either side which provide a light pressure contact, illustrated on the right arm in FIG. 8, only for the elbows contact point #13 and optional wrist strap 70 with hand palm pinkie elastic 70B for pinkie contact point #15, as opposed to a resting arm sling. Illustrated on the left is a shoulder to wrist strap 71 for an intact shoulder, designed to aid reduced coordination or paralysis in an arm and hand, where the wrist strap 70 with hand palm pinkie elastic 70B for pinkie contact point #15 is one modular unit. Also a Wrist/Hand Palm pinkie strap 70 and 70B, would provide increased thumb and finger dexterity for grasping and reduced pain enabling relaxation of the hand.

Clavicle/Shoulder Harness:

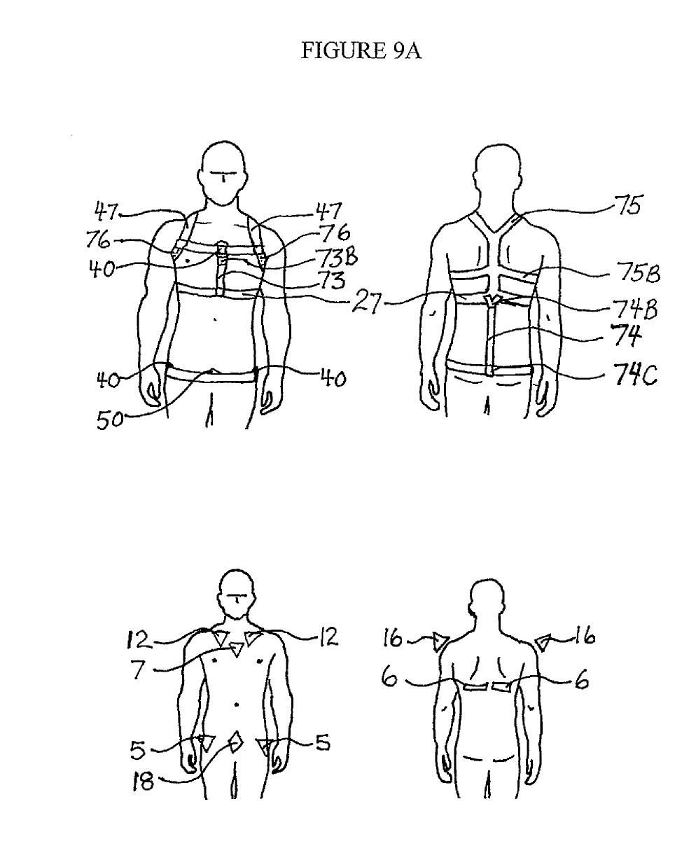

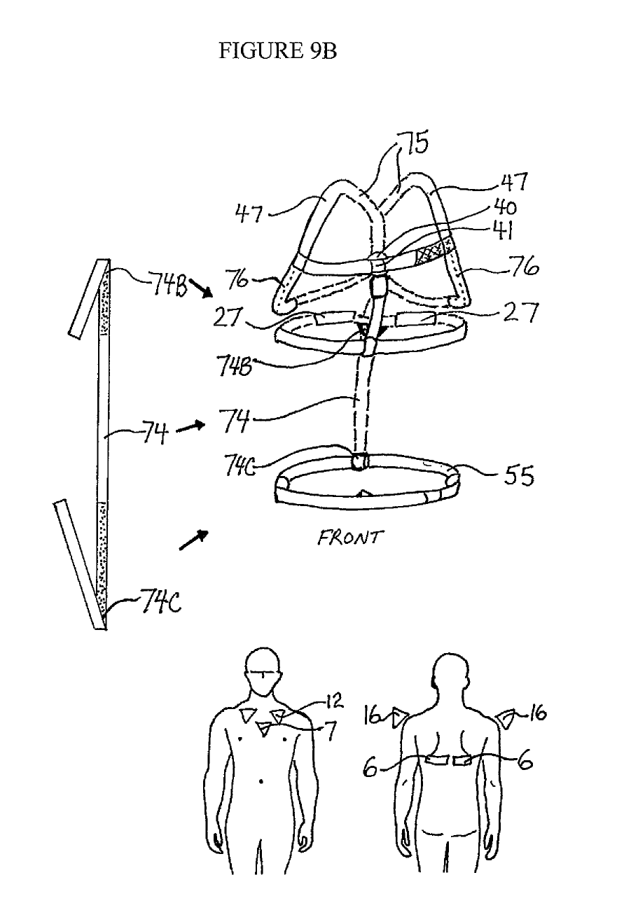

The modular Shoulder support system is specifically designed for improved posture for clavicle subluxation and shoulder dislocation to be used in daily activities, rehabilitation, sports and in pools or showers, while it fits comfortably for female and male anatomy. As shown in FIG. 9A the adjustable 73B sternum strap 73 holds the sternum pad 40 on contact point #7, the front clavicle strap 47 for clavicle contact point #12, both the v neck back strap 75 for shoulder joint contact points #16, and the neoprene underarm strap 76 (clearly detailed in FIG. 9B) are for contact point 416, adjustable mid back strap 27 for mid back contact points #6, these straps are designed to stimulate the correct positioning of the shoulders, while the head and sternum area are naturally uplifted by sternum contact point #7. An optional modular attachment in FIG. 9B of hip/pelvic belt 55 (refer to FIG. 5A) can be independently worn with shoulder harness or connected with adjustable strap 74, which is attached to the back of shoulder harness at 74B and to the back of the hip belt at 74C. In FIG. 9A the front and back views of the complete modular unit are shown as worn on the body utilizing clavicle/shoulder harness, attached to the hip belt with the connecting strap, which further increases natural posture during activity and thereby reducing fatigue.

Other Devices:

In a similar manner, a bed or hammock system can be designed to incorporate the contact point system, including the use of a hammock seat with adjustable foot straps and knee straps for flexion contact points.

To gain a better understanding of the invention described herein, the following examples are set forth. It should be understood that these examples are for illustrative purposes only. Therefore, they should not limit the scope of this invention in any way.

### EXAMPLES

### Example 1

### Case Study of 56 Year Old Female with Chorea Athetoid Cerebral Palsy

In this case, involving the inventor of the present invention, the contact points were developed over a 18 year period by the inventor to improve on existing posture systems in order to alleviate spasms and other postural problems associated with this form of dystonic cerebral palsy. The resulting use of all contact points described in the present invention in chairs, wheelchairs, and other posture systems allowed the inventor to progress to independent functional daily activities and more fine motor coordination for longer durations. Spasms were significantly inhibited. The use of the contact points was more beneficial than even the supine position. She is able to pursue gainful employment, leisure activities, and community activities and live independently.

### Example 2

### Case Study of Grade 5 Male Student with Tourette Syndrome, Anxiety Disorder and Attention Deficit Disorder

A grade 5 enrolled student with a multiple diagnosis, including Tourette Syndrome, Anxiety disorder and Attention Deficit Disorder, was tested and found to be gifted and learning disabled. It was noticed that the student's posture collapsed when the student was trying to concentrate. The student's chair was modified to assist with posture and provide head support, adding the use of several of the contact points. It was subsequently and immediately observed that the student no longer curled over during reading, and could sit in a more upright and relaxed position for writing and listening. The student also noticed the difference and stated that there was a calmer feeling from sitting in the modified chair. He completed the school year successfully with great reduction of his symptoms. Then, in grade six, the next school teacher would not allow him to use the present invention and all his symptoms greatly increased again and school performance declined substantially.

### Example 3

### Case Study of 14 Year Old Female Subject with Myoclonis (Partial Diagnosis Due to Additional Cluster of Motor Symptoms)

A 14 year old female with myoclonis was provided with a wheelchair which had been modified to incorporate many of the contact points described herein. Within 30 minutes, the subject stated that sitting in the chair was more comfortable than other chairs, and required less effort to keep her back straight. Writing was easier, since the subject did not have to struggle to stabilize her arms and upper body. There was less “twitching,” and jerking of the head due to the myoclonis. As a result of sitting in the chair, the subject did not require a head rest, and did not have to struggle to keep from twitching due to the myoclonis.

### Example 4

### Case Study of 23 Year Old Female with Spastic Cerebral Palsy

A 23 year old university student and public speaker with spastic cerebral palsy was provided with a wheelchair which had been modified to incorporate many of the contact points described herein. The subject stated that the chair helped the subject to sit forward (straight), making the subject feel more stable in posture. The subject described feeling “actually safer in your (the inventors) chair”. The subject further stated that the increased angle bending of the knees created a result that all of the muscles in the body seemed less spastic. The subject stated that the modified wheelchair created the ability to sit taller, that her spastic left arm and neck were more relaxed, and that she felt was more stable. The subject was now able to reach for objects on the table, and write more easily.

The subject stated that she was able to now reach and grip the chair wheels, making pushing much easier. This is as opposed to the subjects existing chair, in which motorized wheels were required to move effectively, the back upholstery, was up to the shoulder blades, and a seatbelt was necessary to prevent her from slipping out of the seat.

### Example 5

### Case Study of Grade 4 Male Student with Undiagnosed Low Tone and Identified Learning Challenges

A grade 4 enrolled male student displayed significant difficulties in visual tracking and acuity (i.e. copying materials off the board, etc.), reading delays, quiet speech and low motivation. A classroom chair was individually designed for this individual, which utilized several of the contact points (1, 2, 3, 4, 6, 10) while other contact points were not required.

When the chair was used, improvement was noticed by the individual immediately and by teaching staff within 3 days. Visual tracking, reading silently and aloud, hand eye coordination such as scissor cutting and motivation improved significantly. The subject stated that he did not want to have the chair taken away because of the degree of assistance that it provided, especially for spelling tests.

Because the student used the seating system accumulating an average of 3 hours per day, 5 days per week for an 8 month period (including a 2 month summer holiday without the seating), the student seemed to make significant neurological adjustments of a more stable walking pattern, less dragging of the feet, more upright head posture and more conversation while walking. This was noted by the gym teacher, parents, Learning Assistance teacher and inventor.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### REFERENCES

U.S. Pat. No. 4,617,919 Wheelchair with posture supports, R. Suhre
U.S. Pat. No. 3,635,526 Posture support device, J. Posey
www.mulholland.com
www.spineworx.com

1. A postural support system comprising a plurality of contact surfaces positioned to provide a constant, intermittent pressure to one or more contact points on the body of a user, wherein a contact point is a location on the body of the user that responds to application of pressure to stimulate a more upright posture in the user and wherein the postural support system is adapted to provide the user with a wide range of unrestrained movement when in said upright posture.

2. The postural system of claim 1, wherein the system does not restrain the user in said upright posture.

3. The postural system of claim 1, wherein the one or more contact points are located at the low back, mid back, hip, under thigh, knee, ankle, heel, wrist, elbow, fingers, collarbone, back of head, forehead, upper shin, shoulders, plantar metatarsal, sternum, pinkie, pelvis, or a combination thereof.

4. The postural support system of claim 1, wherein each of the plurality of contact surfaces are adapted to be independently moved into or out of contact with its corresponding contact point on the body of the user.

5. The postural system of claim 1, which is a seating device.

6. The postural system of claim 5, where the postural system is a unit of furniture, such as a chair, seat, stool or bench.

7. The postural system of claim 5, where the postural system is an assisted mobility device, such as a wheelchair, a scooter, or a powerchair.

8. The postural system of claim 5, wherein the seating device has a seat angle of between 60 and 85 degrees, and a foot rest or plate with an angle between 60 and 85 degrees.

9. The postural system of claim 5, wherein the seating device comprises a first contact surface that is an under thigh ridge or pad, second and third contact surfaces that are side hip pads, a fourth contact surface that is a on a low-back strap rest, and fifth contact surface that is a mid-back strap rest.

10. The postural system of claim 5, wherein the seating device comprises a head rest and contact surface that is on a forehead strap adapted to provide pressure to a contact point on the forehead of the user.

11. The postural system of claim 5, wherein the seating device comprises a sternum strap adapted to provide a contact surface to provide pressure to a contact point on the sternum of the user.

12. The postural system of claim 5, wherein the seating device is for use in adapting a standard seating device, such as, a saddle, a canoe seat, a kayak seat, a hammock, a vehicle seat, an airplane seat, or a child or infant booster seat.

13. The posture system of claim 1, wherein the system is a device used during standing and/or walking.

14. The postural system of claim 13, wherein the device is a walker, a standing device, or a human mobility robotics device.

15. The postural system of claim 13, wherein the device comprises a hip or pelvic strap, alternate walking handles and knee stabilizer straps.

16. The postural system of claim 13, wherein the device comprises a sternum strap adapted to provide a contact surface to provide pressure to a contact point on the sternum of the user.

17. The postural system of claim 1, which comprises one or more contact surfaces for providing pressure to contact points on the elbows, hands and/or fingers of the user.

18. The postural system of claim 17, which comprises contact surfaces for providing pressure to contact points located on at least one wrist, at least one elbow, one or more fingers and at least one foot of the user.

19. The postural system of claim 17, which comprises one or more straps to provide pressure on one of more of the wrists, elbow, fingers or feet of the user.

20. The postural system of claim 17 which is a harness and handle for use with a service animal, a set of crutches, or a shoulder harness.

21. The postural system of claim 1, comprising a plurality of straps or harnesses worn by the user.

22. The postural system of claim 21 which is adapted to be worn by the user while seated, walking, running, driving or during sports activities, such as swimming or team sports.

23. The postural system of claim 21, which is used for therapeutic postural positioning of joints and bones, such as, the shoulders.

24. The postural system of claim 1, wherein the system is adapted for use in learning environments to improve sensory and learning integration.

25. The postural system of claim 1, wherein the system is custom fitted to the user.

26. A method of stimulating an upright posture in an individual comprising the step of simultaneously providing constant, intermittent pressure to a plurality of contact points on the individual, wherein a contact point is a location on the body of the individual that responds to application of pressure to stimulate an upright posture in the individual, and wherein the individual maintains a wide range of unrestrained movement during the step of providing constant, intermittent pressure to said plurality of contact points.

27. The method of claim 26, wherein the constant, intermittent pressure is provided using a postural support system having a plurality of contact surfaces that correspond with the plurality of contact points.

28. The method of claim 27, wherein the postural support system is a seating device, a device used during standing, crawling and/or walking, a device that comprises one or more contact surfaces that correspond to contact points on the elbows, hands and/or fingers of the individual, or a device comprising a plurality of straps or harnesses that is worn by the individual.
